(19) United States
(12) Patent Application Publication
(10) Pub. No.: US 2020/0271986 A1
(43) Pub. Date: Aug. 27, 2020

(54) DISPLAY DEVICE AND METHOD OF MANUFACTURING DISPLAY DEVICE

(71) Applicant: Mitsubishi Electric Corporation, Tokyo (JP)

(72) Inventor: Takuya HIGASHI, Tokyo (JP)

(73) Assignee: Mitsubishi Electric Corporation, Tokyo (JP)

(21) Appl. No.: 16/798,262

(22) Filed: Feb. 21, 2020

(30) Foreign Application Priority Data
Feb. 25, 2019 (JP) 2019-031717

(51) Int. Cl. G02F 1/1335; G02F 1/135; G02F 1/1333

(52) U.S. Cl. CPC G02F 1/133512; G02F 2001/1351; G02F 1/133305; G02F 1/135

(57) ABSTRACT

A display panel has a plurality of pixel regions to emit light. A second substrate faces a first substrate across a display medium layer, is transparent, includes a part having a thickness of less than 0.3 mm, and has a main surface on the opposite side to the arrangement side of the first substrate. A light-blocking film is arranged on the main surface and on the part, and overlaps a defective pixel region and projects from the defective pixel region by a width W in a plan view taken from the thickness direction of the display panel. The width W is equal to or more than a width W1 that prevents visual recognition of light emitted from the defective pixel region when the display panel is observed from within a viewing angle.

### FIELD OF THE INVENTION

The present invention relates to a display device and a method of manufacturing the display device.

### BACKGROUND ART

A display device includes a plurality of pixels. In each of the pixels, the brightness level of a light beam emitted from each pixel is controlled. By doing so, an image responsive to the brightness levels of light beams emitted from the pixels is displayed on the display device.

In response to size increase and higher resolution of display devices in recent years, the number of pixels of the display devices is on the increase. For manufacture of the display devices, as the numbers of pixels increase in the display devices, the ratio of display devices with pixels to become defects increases among the manufactured display devices. Hence, the recent increase in the numbers of pixels of the display devices has inhibited improvement of manufacturing yield.

A pixel to become a defect is caused by failing to control the brightness level of light emitted from the pixel due to short-circuit of an electrode for controlling this brightness level, for example. The pixel to become a defect is a pixel such as one to become a bright point defect always in a light-emitting state. The pixel to become a bright point defect is conspicuous in a black background, easily recognizable, and reduces the visual quality of a display device.

In many cases, by performing a process on display devices for making a pixel to become a bright point defect inconspicuous, it becomes possible to provide the display devices with quality permissible for shipment. If the display devices are given quality permissible for shipment through implementation of this process, a ratio of conforming items can be increased among the display devices to achieve cost reduction of the display devices.

According to a technique disclosed in Japanese Patent Application Laid-Open No. 3-243917 (1991), the position of a picture element suffering from a defect of always causing transmission of light is identified (page 3, lines 2 to 3 in upper left column). A light-blocking material is applied to a polarizer side of a substrate, corresponding to the defective picture element (page 3, lines 5 to 6 in upper left column). A light-blocking film is formed by the application of the light-blocking material (page 3, lines 7 to 8 in upper left column). As a result, a bright point is repair (page 3, line 20 in upper right column).

According to a technique disclosed in Japanese Patent Application Laid-Open No. 2006-171057, a recess or a through hole is formed at a position corresponding to a bright point defect at a polarizer (paragraph 0022). The recess or through hole is filled with a light-blocking material (paragraph 0024). As a result, a bright point defect is repaired (paragraph 0027).

According to a technique disclosed in Japanese Patent Application Laid-Open No. 2015-121602, a light-blocking film is formed at a position corresponding to a defective pixel region on an external surface of a second substrate (paragraph 0024). The size of the light-blocking film is larger than the size of a pixel region (paragraph 0024). The light-blocking film is formed to cover a first region and a second region (paragraph 0026). The first region is a region in which the external shape of the defective pixel region is projected on a surface of the second substrate (paragraph 0026). The second region is a region around the first region (paragraph 0026). The light-blocking film has transmittance higher in the second region than in the first region (paragraph 0027). As a result, the pixel defect can become inconspicuous (paragraph 0029). Further, the probability for the light-blocking film to be recognized as a large black spot can be reduced (paragraph 0029). Light traveling diagonally after being emitted from the defective pixel region is blocked appropriately in the second region of the light-blocking film, so that it is unlikely to be recognized as a bright point when observed diagonally from an observer (paragraph 0030). However, light traveling frontward from the pixel region is allowed to pass to some extent through the second region of the light-blocking film, so that it is not blocked completely (paragraph 0030).

A display device has a viewing angle. Thus, what is desired in the display device is not only making a pixel to become a bright point defect inconspicuous when observed from the front but also making a pixel to become a bright point defect inconspicuous when observed diagonally within the viewing angle.

According to the conventional techniques, however, a pixel to become a bright point defect is conspicuous in some cases when a display device is observed diagonally within a viewing angle. Additionally, a pixel adjacent to the pixel to become a bright point defect may be hidden.

According to the technique disclosed in Japanese Patent Application Laid-Open No. 3-243917 (1991), for example, light emitted diagonally from the defective picture element is not blocked. This makes the defective picture element conspicuous when a liquid crystal display device is observed diagonally within a viewing angle.

According to the technique disclosed in Japanese Patent Application Laid-Open No. 2006-171057, light emitted diagonally from the bright point defect is not blocked. This makes the bright point defect conspicuous when a liquid crystal display device is observed diagonally within a viewing angle.

According to the technique disclosed in Japanese Patent Application Laid-Open No. 2015-121602, blocking of light emitted diagonally from the defective pixel region may be prohibited in a manner that depends on the size of the light-blocking film and a direction in which the light is emitted. This makes the defective pixel region conspicuous in some cases when a liquid crystal display device is observed diagonally within a viewing angle. Additionally, according to the technique disclosed in Japanese Patent Application Laid-Open No. 2015-121602, a pixel region adjacent to the defective pixel region may be hidden in a manner that depends on the size of the light-blocking film.

This problem becomes serious, particularly in a display device having a wide viewing angle such as a liquid crystal display device with a liquid crystal display panel of a lateral field system.

### SUMMARY OF THE INVENTION

The present invention is intended to provide a display device that makes a pixel to become a bright point defect inconspicuous when observed from within a viewing angle, makes it unlikely that a pixel adjacent to the pixel to become a bright point defect will be hidden, and has high visual quality.

The present invention is intended for a display device.

The display device includes a display panel and a light-blocking film,

The display panel has a plurality of pixel regions to emit light. The pixel regions include a defective pixel region where a bright point defect has occurred.

The display panel includes a first substrate, a display medium layer, and a second substrate. The second substrate faces the first substrate across the display medium layer. The second substrate is transparent. The second substrate includes a part having a thickness of less than 0.3 mm. The second substrate has a main surface on the opposite side to the arrangement side of the first substrate.

The light-blocking film is arranged on the main surface and on the part. The light-blocking film overlaps the defective pixel region and projects from the defective pixel region by a width W in a plan view taken from the thickness direction of the display panel. The width W is equal to or more than a width W1 that prevents visual recognition of light emitted from the defective pixel region when the display panel is observed from within a viewing angle.

The present invention is also intended for a method of manufacturing the display device.

Light emitted from the defective pixel region is not recognized visually when the display panel is observed from within the viewing angle. This makes a pixel to become a bright point defect inconspicuous when the display panel is observed from within the viewing angle. Preventing visual recognition of light emitted from the defective pixel region when the display panel is observed from within the viewing angle does not require significant increase of the light-blocking film. This makes it unlikely that a pixel adjacent to the pixel to become a bright point defect will be hidden. This makes it possible to provide the display device having high visual quality.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view schematically illustrating a principal part of a display device in which a bright point defect is repaired in the same way as repair of a bright point defect in a liquid crystal display device of each of a first preferred embodiment and a second preferred embodiment;

FIG. 2 is an enlarged sectional view schematically illustrating a principal part of a liquid crystal display device in which a bright point defect is repaired in the same way as repair of a bright point defect in the liquid crystal display device of each of the first preferred embodiment and the second preferred embodiment;

FIG. 3 is a sectional view schematically illustrating the liquid crystal display device of the first preferred embodiment;

FIG. 4 is a perspective view schematically illustrating a principal part of a liquid crystal display panel provided in the liquid crystal display device of the first preferred embodiment;

FIG. 5 is an enlarged sectional view schematically illustrating a principal part of the liquid crystal display device of the first preferred embodiment;

FIG. 6 is a flowchart showing a method of manufacturing the liquid crystal display device of the first preferred embodiment;

FIG. 7 is a flowchart showing the method of manufacturing the liquid crystal display device of the first preferred embodiment;

FIG. 8 is a sectional view schematically illustrating the liquid crystal display device of the second preferred embodiment; and

FIG. 9 is an enlarged sectional view schematically illustrating a principal part of the liquid crystal display device of the second preferred embodiment.

### EMBODIMENT FOR CARRYING OUT THE INVENTION

### 1 Display Device in which Bright Point Defect is Repaired

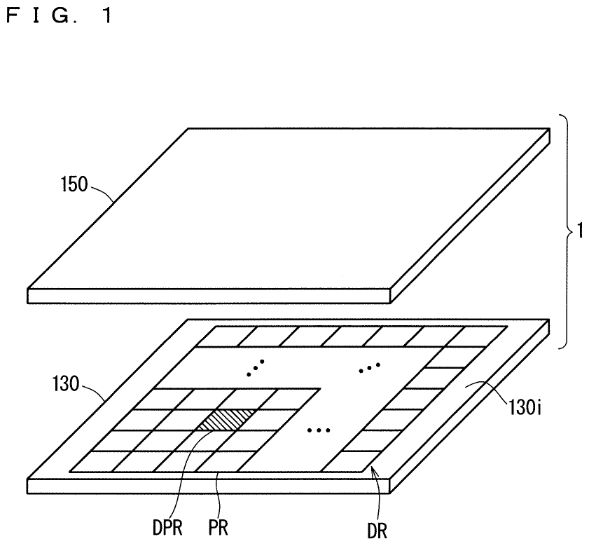

FIG. 1 is an exploded perspective view schematically illustrating a principal part of a display device in which a bright point defect is repaired in the same way as repair of a bright point defect in a liquid crystal display device of each of a first preferred embodiment and a second preferred embodiment.

A display device 1 shown in FIG. 1 includes a first substrate 130 and a second substrate 150. The display device 1 further includes a first layer and a second layer not illustrated.

The second substrate 150 faces the first substrate 130. The first substrate 130 has an internal main surface 130i. The internal main surface 130i is on the arrangement side of the second substrate 150. The internal main surface 130i includes a display region DR. The display region DR is partitioned into a plurality of pixel regions PR. The pixel regions PR are aligned regularly. A defective pixel region DPR is mixed in the pixel regions PR.

The first layer is arranged on the first substrate 130. The second layer is arranged on the second substrate 150.

### 2 Liquid Crystal Display Device in which Bright Point Defect is Repaired

2.1 Liquid Crystal Display Device

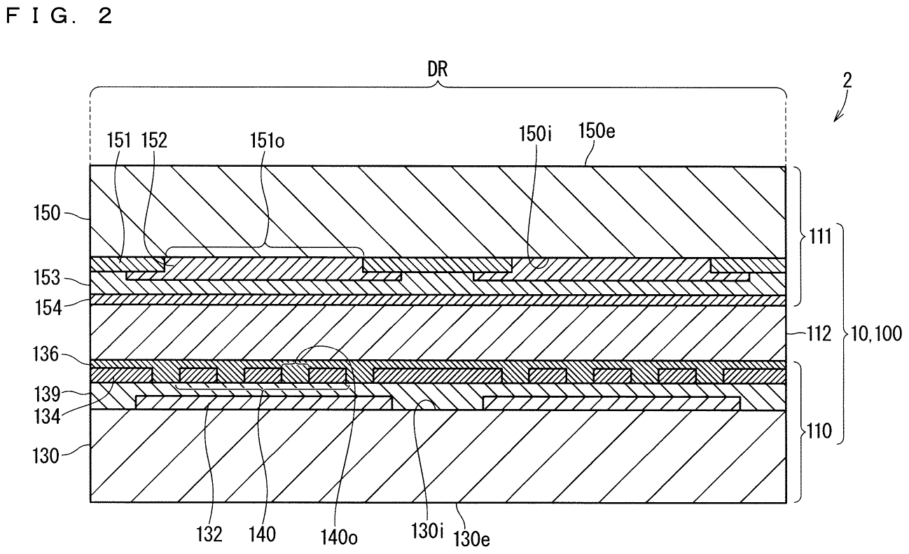

FIG. 2 is an enlarged sectional view schematically illustrating a principal part of a liquid crystal display device in which a bright point defect is repaired in the same way as repair of a bright point defect in the liquid crystal display device of each of the first preferred embodiment and the second preferred embodiment. FIG. 2 illustrates a part forming two pixels.

A liquid crystal display device 2 illustrated in FIG. 2 is an example of the display device 1 illustrated in FIG. 1. The display device 1 may be a display device other than the liquid crystal display device 2.

The liquid crystal display device 2 includes a liquid crystal display panel 10. The liquid crystal display device 2 includes a backlight not illustrated.

The liquid crystal display panel 10 is a liquid crystal display panel of a lateral field system having a wide viewing angle. If the liquid crystal display panel 10 is a liquid crystal display panel of a lateral field system having a wide viewing angle, making the following repair of a bright point defect in the liquid crystal display panel 10 produces notable effect resulting from this defect repair. Alternatively, the liquid crystal display panel 10 may be a liquid crystal display panel of a vertical field system. For example, the liquid crystal display panel 10 may be a liquid crystal display panel of a vertical alignment (VA) system having a relatively wide viewing angle. Still alternatively, the liquid crystal display panel 10 may be a liquid crystal display panel of a twisted nematic (TN) system generally not having a wide viewing angle but improved so as to be given a wide viewing angle by the addition of a viewing angle compensation (wide view) film, for example.

The liquid crystal display panel 10 is a liquid crystal display panel of a fringe-field switching (FFS) system as one of lateral field systems. The liquid crystal display panel 10 may be a liquid crystal display panel of a system other than the FFS system. For example, the liquid crystal display panel 10 may be a liquid crystal display panel of an in-plane switching (IPS (registered trademark)) system.

The backlight emits light. The liquid crystal display panel 10 causes part of the emitted light to pass through. The liquid crystal display panel 10 has an in-plane distribution of light transmittance responsive to an input signal. In this way, an image responsive to the signal input to the liquid crystal display panel 10 is displayed on the liquid crystal display device 2.

2.2 Liquid Crystal Display Panel

As illustrated in FIG. 2, the liquid crystal display panel 10 includes a display region DR. The liquid crystal display panel 10 has a frame region not illustrated. An image is displayed in the display region DR. The frame region is arranged outside the display region DR and surrounds the display region DR.

As illustrated in FIG. 2, the liquid crystal display panel 10 includes a liquid crystal cell 100. As illustrated in FIG. 2, the liquid crystal cell 100 includes an array substrate 110, a counter substrate 111, and a liquid crystal layer 112. The liquid crystal cell 100 includes a sealing member and a spacer not illustrated.

The counter substrate 111 faces the array substrate 110. The liquid crystal layer 112, the sealing member, and the spacer are caught between the array substrate 110 and the counter substrate 111. The liquid crystal layer 112 and the spacer are arranged in the display region DR. The sealing member is arranged in the frame region. The sealing member is used for bonding the array substrate 110 and the counter substrate 111 to each other and for sealing the liquid crystal layer 112 in a gap between the array substrate 110 and the counter substrate 111. The spacer is for maintaining the width of this gap at a specific width.

As illustrated in FIG. 2, the array substrate 110 includes a first transparent substrate 130.

The first transparent substrate 130 functions as a base. The first transparent substrate 130 is made of a transparent material having insulating properties. The transparent material having insulating properties is glass, quartz, or a plastic, for example.

The first transparent substrate 130 has an internal main surface 130i and an external main surface 130e. The internal main surface 130i is on the arrangement side of a second transparent substrate 150 described below. The external main surface 130e is on the opposite side to the arrangement side of the second transparent substrate 150 described below.

As illustrated in FIG. 2, the array substrate 110 includes a pixel electrode 132, an interelectrode insulating film 139, a common electrode 134, and an alignment film 136. The array substrate 110 further includes a layer not illustrated.

The pixel electrode 132, the interelectrode insulating film 139, the common electrode 134, and the alignment film 136 are arranged over the internal main surface 130i of the first transparent substrate 130.

The pixel electrode 132 is arranged on the internal main surface 130i of the first transparent substrate 130. The pixel electrode 132 is made of a transparent material having conductivity. The transparent material having conductivity is indium tin oxide (ITO) or indium zinc oxide (IZO) (IZO is a registered trademark owned by Idemitsu Kosan Co., Ltd.), for example.

The interelectrode insulating film 139 is stacked on the pixel electrode 132 and arranged on the internal main surface 130i of the first transparent substrate 130, and covers the pixel electrode 132. The interelectrode insulating film 139 is made of a transparent material having insulating properties. The transparent material having insulating properties is silicon nitride or silicon oxide, for example. The interelectrode insulating film 139 is provided to separate the pixel electrode 132 and the common electrode 134 from each other to electrically insulate the pixel electrode 132 and the common electrode 134 from each other.

The common electrode 134 is arranged on the interelectrode insulating film 139. The common electrode 134 includes a slit electrode 140. The slit electrode 140 has a plurality of openings 140o. In a plan view taken from the thickness direction of the array substrate 110, the slit electrode 140 overlaps the pixel electrode 132 and faces the pixel electrode 132 across the interelectrode insulating film 139. Each of the openings 140o has a slit-like shape. The common electrode 134 is made of a transparent material having conductivity. The transparent material having conductivity is ITO or IZO, for example.

The alignment film 136 is stacked on the common electrode 134, arranged on the interelectrode insulating film 139, and covers the common electrode 134. The alignment film 136 is made of polyimide, for example. The alignment film 136 is subjected to molecular alignment process. The molecular alignment process is rubbing or light irradiation, for example. The alignment film 136 functions to align liquid crystal molecules in the liquid crystal layer 112.

As illustrated in FIG. 2, the counter substrate 111 includes the second transparent substrate 150.

The second transparent substrate 150 functions as a base. The second transparent substrate 150 faces the first transparent substrate 130 across the liquid crystal layer 112. The second transparent substrate 150 is made of a transparent material having insulating properties. The transparent material having insulating properties is glass, quartz, or a plastic, for example.

The second transparent substrate 150 has an internal main surface 150i and an external main surface 150e. The internal main surface 150i is on the arrangement side of the first transparent substrate 130. The external main surface 150e is on the opposite side to the arrangement side of the first transparent substrate 130.

As illustrated in FIG. 2, the counter substrate 111 includes a light-blocking layer 151, a colored layer 152, an overcoat (OC) layer 153, and an alignment film 154. The counter substrate 111 further includes a layer not illustrated.

The light-blocking layer 151, the colored layer 152, the OC layer 153, and the alignment film 154 are arranged over the internal main surface 150i of the second transparent substrate 150.

The light-blocking layer 151 is arranged on the internal main surface 150i of the second transparent substrate 150. The light-blocking layer 151 is for blocking light. The light-blocking layer 151 has a plurality of openings 1510.

The colored layer 152 is arranged on the internal main surface 150i of the second transparent substrate 150 and closes the openings 1510 at the light-blocking layer 151. The colored layer 152 causes light of a specific color to pass through selectively.

The OC layer 153 is arranged on the light-blocking layer 151 and the colored layer 152. The OC layer 153 is made of transparent resin. The transparent resin is photoresist, for example. The OC layer 153 covers a step formed by the light-blocking layer 151 and the colored layer 152 to provide a flat surface, and intercepts flow of impurities out of the light-blocking layer 151 and the colored layer 152 into the liquid crystal layer 112.

The alignment film 154 is arranged on the OC layer 153. The alignment film 154 is made of polyimide, for example. The alignment film 154 is subjected to molecular alignment process. The molecular alignment process is rubbing or light irradiation, for example. The alignment film 154 functions to align liquid crystal molecules in the liquid crystal layer 112 in the same orientation as an orientation in which the liquid crystal molecules in the liquid crystal layer 112 are aligned by the alignment film 136.

The counter substrate 111 includes a transparent conductive film not illustrated.

The transparent conductive film is arranged on the external main surface 150e of the second transparent substrate 150. Like the pixel electrode 132 and the common electrode 134, the transparent conductive film is made of a transparent material having conductivity. The transparent material having conductivity is ITO or IZO, for example. The transparent conductive film is electrically grounded. The transparent conductive film functions to prevent electrostatic charging, display failure due to an external electric field, etc.

The liquid crystal display panel 10 includes a first polarizer, a first adhesive layer, a second polarizer, and a second adhesive layer not illustrated.

The first polarizer and the first adhesive layer are arranged on the external main surface 130e of the first transparent substrate 130. The second polarizer and the second adhesive layer are arranged on the external main surface 150e of the second transparent substrate 150. The first polarizer and the second polarizer are arranged to extend in the display region DR entirely.

The first adhesive layer is used for bonding the first polarizer to the external main surface 130e of the first transparent substrate 130. The second adhesive layer is used for bonding the second polarizer to the external main surface 150e of the second transparent substrate 150.

The first polarizer causes polarized light having a specific polarizing direction to pass through selectively. The liquid crystal cell 100 modulates the polarizing direction of light to pass through in response to a signal input to the liquid crystal display panel 10. The second polarizer causes polarized light having a specific polarizing direction to pass through selectively. By doing so, the liquid crystal display panel 10 is given an in-plane distribution of light transmittance responsive to the input signal.

When a signal is input to the liquid crystal display panel 10, a pixel potential responsive to the signal input to the liquid crystal display panel 10 is applied to the pixel electrode 132. Further, a common potential is applied to the common electrode 134. By doing so, a potential difference responsive to the signal input to the liquid crystal display panel 10 is applied between the pixel electrode 132 and the common electrode 134. Then, an electric field responsive to the applied potential difference is generated between the pixel electrode 132 and the slit electrode 140 facing the pixel electrode 132. The generated electric field passes through the opening 140o at the slit electrode 140 and the liquid crystal layer 112. The electric field passing through the liquid crystal layer 112 includes a lateral electric field parallel to the internal main surface 130i of the first transparent substrate 130. The lateral electric field changes the state of alignment of liquid crystal molecules in the liquid crystal layer 112. In this way, the liquid crystal cell 100 modulates the polarizing direction of light to pass through in response to the signal input to the liquid crystal display panel 10.

As the state of alignment of liquid crystal molecules in the liquid crystal layer 112 is changed, the liquid crystal layer 112 becomes functional as a display medium layer on which a latent image is formed. The formed latent image is visualized by the first polarizer and the second polarizer.

After light enters the liquid crystal cell 100, the light passes through the array substrate 110, the liquid crystal layer 112, the alignment film 154, and the OC layer 153 sequentially to reach the light-blocking layer 151 and the opening 1510 at the light-blocking layer 151. The light having reached the light-blocking layer 151 is blocked by the light-blocking layer 151. The light having reached the opening 1510 passes through the colored layer 152 and the second transparent substrate 150 sequentially to exit the liquid crystal cell 100. Thus, a region in which the light-blocking layer 151 is arranged becomes a black region not causing exit of light to form an image. Further, regions where the openings 1510 are arranged become a plurality of pixel regions causing exit of light to form an image. The black region separates adjacent ones of the pixel regions from each other.

### 3 First Preferred Embodiment

3.1 Liquid Crystal Display Device

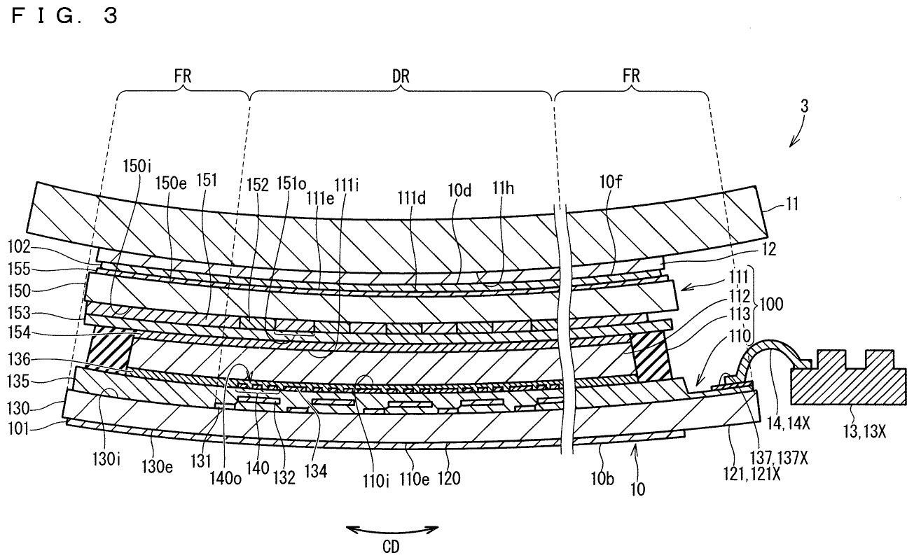

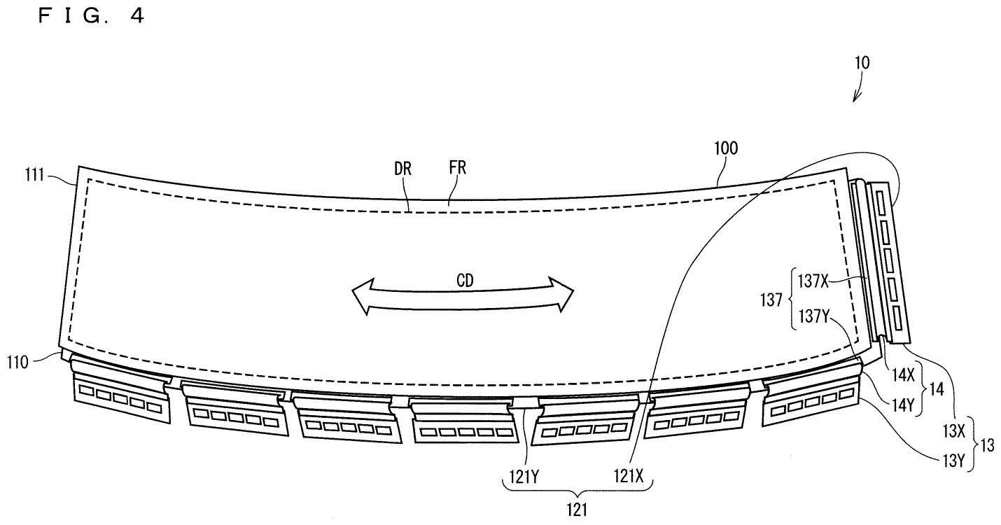

FIG. 3 is a sectional view schematically illustrating the liquid crystal display device of the first preferred embodiment. FIG. 4 is a perspective view schematically illustrating a principal part of a liquid crystal display panel provided in the liquid crystal display device of the first preferred embodiment.

In a liquid crystal display device 3 of the first preferred embodiment illustrated in FIG. 3, a bright point defect is repaired in the following way.

The liquid crystal display device 3 is a curved liquid crystal display device.

As illustrated in FIG. 3, the liquid crystal display device 3 includes a liquid crystal display panel 10, a transparent protective cover 11, and a transparent adhesive sheet 12. The liquid crystal display device 3 further includes a backlight, an optical sheet, and a housing not illustrated.

The liquid crystal display panel 10, the transparent protective cover 11, the transparent adhesive sheet 12, the backlight, and the optical sheet have curved shapes. The liquid crystal display panel 10 having a curved shape is obtained by deforming the liquid crystal display panel 10 having a flat shape and fixing the deformed liquid crystal display panel 10 to the transparent protective cover 11 originally having the curved shape. The liquid crystal display panel 10, the transparent protective cover 11, the transparent adhesive sheet 12, the backlight, and the optical sheet are curved in a curvature direction CD.

The liquid crystal display panel 10 includes a front side 10f and a back side 10b. The front side 10f has a display surface 10d. The display surface 10d is for display of an image. The display surface 10d has a curved shape curved in the curvature direction CD.

The transparent protective cover 11 faces the front side 10f of the liquid crystal display panel 10 across the transparent adhesive sheet 12. The backlight faces the back side 10b of the liquid crystal display panel 10 across the optical sheet.

The liquid crystal display panel 10, the transparent protective cover 11, the transparent adhesive sheet 12, the backlight, and the optical sheet are housed in the housing. The housing has an opening. The display surface 10d of the liquid crystal display panel 10 faces the opening through the transparent protective cover 11 and the transparent adhesive sheet 12.

The liquid crystal display panel 10 is a liquid crystal display panel of a lateral field system. The liquid crystal display panel of a lateral field system has a wide viewing angle. Thus, making the following repair of a bright point defect in the liquid crystal display panel 10 produces notable effect resulting from this defect repair.

The liquid crystal display panel 10 is a liquid crystal display panel of an FFS system as one of lateral field systems.

The transparent protective cover 11 includes a holding surface 11h. The holding surface 11h is curved in the curvature direction CD and has a specific curvature. The transparent protective cover 11 covers the liquid crystal display panel 10.

The transparent adhesive sheet 12 is used for bonding the liquid crystal display panel 10 to the holding surface 11h of the transparent protective cover 11. In this way, the liquid crystal display panel 10 is fixed to the transparent protective cover 11 while being deformed into the curved shape.

Providing the transparent protective cover 11 and the transparent adhesive sheet 12 to the liquid crystal display device 3 improves the resistance of the liquid crystal display device 3 to external pressure applied from the direction of the front side 10f of the liquid crystal display panel 10 and improves the moisture resistance of the liquid crystal display device 3.

The backlight emits light. The optical sheet causes the emitted light to pass through. The optical sheet controls the light to pass through in terms of a polarized state, directivity, etc. The liquid crystal display panel 10 causes part of the light controlled in terms of a polarized state, directivity, etc. to pass through. The liquid crystal display panel 10 has an in-plane distribution of light transmittance responsive to an input signal. As a result, the liquid crystal display device 3 displays an image responsive to the signal input to the liquid crystal display panel 10. The displayed image is visually recognized through the opening at the housing with the transparent protective cover 11 and the transparent adhesive sheet 12 in between.

3.2 Liquid Crystal Display Panel

As illustrated in FIGS. 3 and 4, the liquid crystal display panel 10 has a display region DR and a frame region FR in a plan view taken from the thickness direction of the liquid crystal display panel 10. An image is displayed in the display region DR. The frame region FR is arranged outside the display region DR and surrounds the display region DR. The liquid crystal display panel 10 includes a plurality of pixels. The pixels are arranged in the display region DR.

As illustrated in FIGS. 3 and 4, the liquid crystal display panel 10 includes a liquid crystal cell 100. As illustrated in FIGS. 3 and 4, the liquid crystal cell 100 includes an array substrate 110, a counter substrate 111, a liquid crystal layer 112, and a sealing member 113. The liquid crystal cell 100 further includes a columnar spacer not illustrated.

The counter substrate 111 faces the array substrate 110. The array substrate 110 is arranged closer to the back side 10b of the liquid crystal display panel 10. The counter substrate 111 is arranged closer to the front side 10f of the liquid crystal display panel 10. The liquid crystal layer 112, the sealing member 113, and the columnar spacer are caught between the array substrate 110 and the counter substrate 111. The liquid crystal layer 112 and the columnar spacer are arranged in the display region DR. The sealing member 113 is arranged in the frame region FR. The sealing member 113 is used for bonding the array substrate 110 and the counter substrate 111 to each other and for sealing the liquid crystal layer 112 in a gap between the array substrate 110 and the counter substrate 111. The columnar spacer is for maintaining the width of this gap at a specific width.

The array substrate 110 is a TFT array substrate with a TFT 131. The counter substrate 111 is a color filter substrate with a color filter 152.

The array substrate 110 has an internal main surface 110i and an external main surface 110e. The internal main surface 110i is on the arrangement side of the counter substrate 111. The external main surface 110e is on the opposite side to the arrangement side of the counter substrate 111. The counter substrate 111 has an internal main surface 111i and an external main surface 111e. The internal main surface 111i is on the arrangement side of the array substrate 110. The external main surface 111e is on the opposite side to the arrangement side of the array substrate 110.

The array substrate 110 and the counter substrate 111 each have a rectangular planar shape, for example. The planar shape of the array substrate 110 is larger than the planar shape of the counter substrate 111. For this reason, as illustrated in FIGS. 3 and 4, the array substrate 110 includes an overlapping part 120 and a projecting part 121. The overlapping part 120 overlaps the counter substrate 111. The projecting part 121 projects from an end portion of the counter substrate 111. As illustrated in FIGS. 3 and 4, the projecting part 121 includes a projecting part 121X and a projecting part 121Y. The projecting part 121X projects from a right end portion of the counter substrate 111 and is provided at a right end portion of the array substrate 110. The projecting part 121Y projects from a lower end portion of the counter substrate 111 and is provided at a lower end portion of the array substrate 110. The right end portion and the lower end portion of the array substrate 110 are adjacent to each other. The right end portion and the lower end portion of the counter substrate 111 are adjacent to each other.

The external main surface 111e of the counter substrate 111 has a display surface 111d. The display surface 111d is arranged in the display region DR. The liquid crystal display panel 10 is curved in such a manner that the external main surface 111e and the display surface 111d of the counter substrate 111 each become a concave surface and have a specific curvature. The liquid crystal display panel 10 may be curved in such a manner that the external main surface 111e and the display surface 111d of the counter substrate 111 each become a convex surface in response to a purpose of use of the liquid crystal display device 3.

The curvature direction CD is a direction having a maximum curvature. The curvature direction CD is parallel to the longitudinal direction of the liquid crystal cell 100. If the array substrate 110 and the counter substrate 111 each have a rectangular planar shape, the longitudinal direction of the liquid crystal cell 100 corresponds to a direction in which the long sides of the rectangular planar shape extend.

The sealing member 113 is made of resin, for example.

Desirably, the columnar spacer has a dual spacer structure. The columnar spacer having the dual spacer structure includes columnar spacers of two different types. The columnar spacers of two different types are composed of a main spacer and a sub spacer. The main spacer and the sub spacer are mixed. The main spacer is a spacer having a relatively great height, or a spacer having a relatively great length in a direction vertical to the internal main surface 110i of the array substrate 110 and the internal main surface 111i of the counter substrate 111. The sub spacer is a spacer having a relatively low height, or a spacer having a relatively short length in the direction vertical to the internal main surface 110i of the array substrate 110 and the internal main surface 111i of the counter substrate 111. If the columnar spacer is fixed to the counter substrate 111, the main spacer normally abuts on the array substrate 110 to contribute to sustention of the width of the gap. However, the sub spacer does not abut on the array substrate 110 and does not contribute to sustention of the width of the gap. The sub spacer abuts on the array substrate 110 only when the width of the gap is reduced by the application of external force, for example, to contribute to sustention of the width of the gap.

3.3 Array Substrate

As illustrated in FIG. 3, the array substrate 110 includes a first transparent substrate 130.

The first transparent substrate 130 functions as a base. The first transparent substrate 130 is made of a transparent material having insulating properties. The transparent material having insulating properties is glass, quartz, or a plastic, for example. In the following description, the transparent material having insulating properties is glass and the first transparent substrate 130 is a first glass substrate.

The first glass transparent substrate 130 has an internal main surface 130i and an external main surface 130e. The internal main surface 130i is on the arrangement side of a second glass substrate 150 described below. The external main surface 130e is on the opposite side to the arrangement side of the second glass substrate 150 described below.

As illustrated in FIG. 3, the array substrate 110 includes a switching element 131, a pixel electrode 132, a common electrode 134, an insulating film 135, and an alignment film 136. The array substrate 110 further includes a plurality of scanning signal lines and a plurality of image signal lines not illustrated.

The switching element 131, the pixel electrode 132, the common electrode 134, the insulating film 135, and the alignment film 136 are arranged over the internal main surface 130i of the first glass substrate 130. The switching element 131, the pixel electrode 132, the common electrode 134, the insulating film 135, and the alignment film 136 are arranged in the display region DR.

The scanning signal line, the image signal line, and the switching element 131 are arranged on the internal main surface 130i of the first glass substrate 130. The scanning signal line transmits a scanning signal responsive to a signal input to the liquid crystal display panel 10. The image signal line transmits an image signal responsive to the signal input to the liquid crystal display panel 10. The switching element 131 switches the transmitted image signal in response to the transmitted scanning signal, and applies a pixel potential responsive to the switched image signal to the pixel electrode 132. In this way, the pixel potential responsive to the signal input to the liquid crystal display panel 10 is applied to the pixel electrode 132. The scanning signal line and the image signal line are made of metal films. Thus, the scanning signal line and the image signal line function as light-blocking layers. In the following description, the scanning signal line is a gate line, the image signal line is a source line, and the switching element 131 is a TFT.

The TFT 131 includes a semiconductor layer, a gate electrode, a source electrode, and a drain electrode not illustrated.

The semiconductor layer functions as an active layer. The gate electrode, the source electrode, and the drain electrode are stacked on the semiconductor layer. The gate electrode is electrically connected to the gate line. The gate electrode may be a part of the gate line. The source electrode is electrically connected to the source line. The drain electrode is electrically connected to the pixel electrode 132. In FIG. 3, the electrical connection between the drain electrode and the pixel electrode 132 is drawn conceptually as a line connecting the TFT 131 the pixel electrode 132. The gate electrode, the source electrode, and the drain electrode are made of metal films. Thus, the gate electrode, the source electrode, and the drain electrode function as light-blocking layers.

The pixel electrode 132 is arranged on the internal main surface 130i of the first glass substrate 130. The pixel electrode 132 is a flat-plate electrode having a flat-plate shape. The pixel electrode 132 is made of a transparent material having conductivity. The transparent material having conductivity is ITO or IZO, for example.

The insulating film 135 is stacked on the gate line, the source line, the TFT 131, and the pixel electrode 132, arranged on the internal main surface 130i of the first glass substrate 130, and covers the gate line, the source line, the TFT 131, and the pixel electrode 132. The insulating film 135 is made of a transparent material having insulating properties.

The insulating film 135 includes an insulating film separating the semiconductor layer, the gate electrode, the source electrode, and the drain electrode forming the TFT 131 from each other to electrically insulate the semiconductor layer, the gate electrode, the source electrode, and the drain electrode from each other. The insulating film 135 includes an insulating film covering the TFT 131. The insulating film 135 further includes an interelectrode insulating film separating the pixel electrode 132 and the common electrode 134 from each other to electrically insulate the pixel electrode 132 and the common electrode 134 from each other. In FIG. 3, a group of these insulating films is drawn as one insulating film. Each of these insulating films may be a single-layer film composed of one insulating film, or may be a stacked film composed of a plurality of insulating films.

The common electrode 134 is arranged on the insulating film 135. Thus, the common electrode 134 is arranged in a layer higher than the pixel electrode 132. The common electrode 134 includes a slit electrode 140. The slit electrode 140 has a plurality of openings 140o. In a plan view taken from the thickness direction of the array substrate 110, the slit electrode 140 overlaps the pixel electrode 132 and faces the pixel electrode 132 across the insulating film 135. Each of the openings 140o has a slit-like shape. The common electrode 134 may have an opening overlapping the TFT 131 in a plan view taken from the thickness direction of the array substrate 110. The common electrode 134 is made of a transparent material having conductivity. The transparent material having conductivity is ITO or IZO, for example.

Both the pixel electrode 132 and the common electrode 134 may be a comb-like electrode having a comb-like shape generally provided in a liquid crystal display panel of a lateral field system. The pixel electrode 132 may be arranged in a layer higher than the common electrode 134, the pixel electrode 132 may be a slit electrode, and the common electrode 134 may include a flat-plate electrode.

The alignment film 136 is stacked on the common electrode 134, arranged on the insulating film 135, and covers the common electrode 134. The alignment film 136 is made of polyimide, for example. The alignment film 136 is subjected to molecular alignment process. The molecular alignment process is rubbing or light irradiation, for example. The alignment film 136 functions to align liquid crystal molecules in the liquid crystal layer 112.

3.4 Counter Substrate

As illustrated in FIG. 3, the counter substrate 111 includes a second transparent substrate 150.

The second transparent substrate 150 functions as a base. The second transparent substrate 150 faces the first transparent substrate 130 across the liquid crystal layer 112. The second transparent substrate 150 is made of a transparent material having insulating properties. The transparent material having insulating properties is glass, quartz, or a plastic, for example. In the following description, the transparent material having insulating properties is glass and the second transparent substrate 150 is a second glass substrate.

The second glass substrate 150 has an internal main surface 150i and an external main surface 150e. The internal main surface 150i is on the arrangement side of the first glass substrate 130. The external main surface 150e is on the opposite side to the arrangement side of the first glass substrate 130.

As illustrated in FIG. 3, the counter substrate 111 includes a light-blocking layer 151, a colored layer 152, an OC layer 153, and an alignment film 154.

The light-blocking layer 151, the colored layer 152, the OC layer 153, and the alignment film 154 are arranged over the internal main surface 150i of the second glass substrate 150. The colored layer 152 and the alignment film 154 are arranged in the display region DR. The light-blocking layer 151 and the OC layer 153 are arranged in the display region DR and the frame region FR.

The light-blocking layer 151 is arranged on the internal main surface 150i of the second glass substrate 150. The light-blocking layer 151 is for blocking light. The light-blocking layer 151 blocks a region between regions in which the adjacent colored layers 152 are arranged, and blocks the frame region FR from light. The light-blocking layer 151 is also called a black matrix. The black matrix 151 has a plurality of openings 151o.

The colored layer 152 is arranged on the internal main surface 150i of the second glass substrate 150 and closes the openings 1510 at the black matrix 151. The colored layer 152 causes light of a specific color to pass through selectively. The colored layer 152 is also called a color filter. The color filter 152 includes color filters of three types for causing corresponding ones of three primary colors, red (R), green (G), and blue (B), to pass through selectively. The color filters of three types are aligned linearly.

The OC layer 153 is arranged on the black matrix 151 and the color filter 152. The OC layer 153 is made of transparent resin. The transparent resin is photoresist, for example. The OC layer 153 covers a step formed by the black matrix 151 and the color filter 152 to provide a flat surface, and intercepts flow of impurities out of the light-blocking layer 151 and the color filter 152 into the liquid crystal layer 112.

The alignment film 154 is arranged on the OC layer 153. The alignment film 154 is made of polyimide, for example. The alignment film 154 is subjected to molecular alignment process. The molecular alignment process is rubbing or light irradiation, for example. The alignment film 154 functions to align liquid crystal molecules in the liquid crystal layer 112 in the same orientation as an orientation in which the liquid crystal molecules in the liquid crystal layer 112 are aligned by the alignment film 136.

The foregoing columnar spacer is fixedly attached to the internal main surface 111i of the counter substrate 111 and is fixedly attached to a surface of the OC layer 153.

As illustrated in FIG. 3, the counter substrate 111 includes a transparent conductive film 155.

The transparent conductive film 155 is arranged on the external main surface 150e of the second glass substrate 150. The transparent conductive film 155 is arranged to extend in the display region DR entirely. The transparent conductive film 155 is made of a transparent material having conductivity. The transparent material having conductivity is ITO or IZO, for example. The transparent conductive film 155 is electrically grounded. The transparent conductive film 155 is also called “back side ITO,” for example, and functions to prevent electrostatic charging, display failure due to an external electric field, etc.

3.5 Thickness of Glass Substrate

Desirably, each of the first glass substrate 130 and the second glass substrate 150 has a thickness of less than 0.2 mm. This increases the flexibility of each of the first glass substrate 130 and the second glass substrate 150, so that the liquid crystal display panel 10 having the curved shape is obtained easily through deformation of the liquid crystal display panel 10 having a flat shape. Each of the first glass substrate 130 and the second glass substrate 150 having a thickness of less than 0.2 mm can be obtained by thinning a glass substrate, for example. Still desirably, each of the first glass substrate 130 and the second glass substrate 150 has a thickness of about 0.15 mm. In this case, the thickness of each of the first glass substrate 130 and the second glass substrate 150 is controlled in such a manner that a center value is set at 0.15 mm and variations from the center value fall within a range of plus and minus 20%. Forming each of the first glass substrate 130 and the second glass substrate 150 into such an extremely small thickness makes it possible to deform the liquid crystal display panel 10 having the flat shape easily, so that notable effect can be achieved by the repair of a bright point defect described below.

3.6 Supply of Scanning Signal and Image Signal

As illustrated in FIGS. 3 and 4, the liquid crystal display panel 10 includes a control substrate 13 and a flexible flat cable (FFC) 14. As illustrated in FIGS. 3 and 4, the array substrate 110 includes a signal terminal 137. The array substrate 110 includes a driving integrated circuit (IC) chip and a lead-out line not illustrated. The control substrate 13 includes a control IC chip not illustrated. As illustrated in FIG. 4, the control substrate 13 includes a control substrate 13X and a control substrate 13Y. As illustrated in FIG. 4, the FFC 14 includes an FFC 14X and an FFC 14Y. As illustrated in FIG. 4, the signal terminal 137 includes a signal terminal 137X and a signal terminal 137Y. The driving IC chip includes a driving IC chip for gate line and a driving IC chip for source line not illustrated. The lead-out line includes a lead-out line for gate line and a lead-out line for source line not illustrated.

The signal terminal 137, the driving IC chip, and the lead-out line are arranged on the internal main surface 130i of the first glass substrate 130. The signal terminal 137 and the driving IC chip are arranged in the frame region FR and provided at the projecting part 121. The signal terminal 137 includes a plurality of pads. The pads are aligned in a direction in which an end face of the array substrate 110 extends. Each of the pads has a rectangular planar shape.

The signal terminal 137X and the driving IC chip for gate line are provided at the projecting part 121X. The signal terminal 137Y and the driving IC chip for source line are provided at the projecting part 121Y.

The control substrate 13X is electrically connected to the pads at the signal terminal 137X through the FFC 14X. The pads at the signal terminal 137X are electrically connected to the input side of the driving IC chip for gate line. The output side of the driving IC chip for gate line is electrically connected to the gate line through the lead-out line for gate line. The control substrate 13Y is electrically connected to the pads at the signal terminal 137Y through the FFC 14Y. The pads at the signal terminal 137Y are electrically connected to the input side of the driving IC chip for source line. The output side of the driving IC chip for source line is electrically connected to the source line through the lead-out line for source line.

The control IC chip at the control substrate 13X generates a control signal including a plurality of different signals. The FFC 14X transmits the generated control signal from the control substrate 13X to the signal terminal 137X. The driving IC chip for gate line generates a scanning signal responsive to the transmitted control signal. The lead-out line for gate line transmits the generated scanning signal from the driving IC chip for gate line to the gate line. In this way, the scanning signal is supplied to the gate line. The control IC chip at the control substrate 13Y generates a control signal including a plurality of different signals. The FFC 14Y transmits the generated control signal from the control substrate 13Y to the signal terminal 137Y. The driving IC chip for source line generates an image signal responsive to the transmitted control signal. The lead-out line for source line transmits the generated image signal from the driving IC chip for source line to the source line. In this way, the image signal is supplied to the source line.

The FFC 14 may be replaced with a connection line of a different type.

Two types of element groups including an element group for supplying a scanning signal composed of the control substrate 13X, the FFC 14X, and the signal terminal 137X, and an element group for supplying an image signal composed of the control substrate 13Y, the FFC 14Y, and the signal terminal 137Y may be replaced with one type of element group for supplying a scanning signal and an image signal composed of a control substrate, an FFC, and a signal terminal. The signal terminal forming this one type of element group may be provided either at the projecting part 121X or at the projecting part 121Y.

3.7 Grounding of Transparent Conductive Film

The liquid crystal display panel 10 includes conductive tape not illustrated. The array substrate 110 includes an earth pad not illustrated. The earth pad is provided at the projecting part 121.

One end of the conductive tape is bonded to the earth pad. The other end of the conductive tape is bonded to the transparent conductive film 155. By doing so, the transparent conductive film 155 is electrically connected to the earth pad through the conductive tape. As a result, the transparent conductive layer 155 is grounded.

The conductive tape includes a base material and a conductive adhesive layer. The base material is made of metal foil. The metal foil is aluminum (Al) foil or copper (Cu) foil, for example. The conductive adhesive layer is arranged on the base material. The conductive adhesive layer is formed by applying a conductive adhesive agent onto the base material. The conductive tape may be commercially-available general conductive tape.

The conductive tape may be replaced with a conductive paste film. The conductive paste film is arranged to extend over the transparent conductive layer 155 and the earth pad. The conductive paste film is formed by applying conductive paste from the transparent conductive layer 155 to the earth pad. The conductive paste may be general conductive paste such as silver paste, for example.

3.8 Polarizer

The liquid crystal display panel 10 includes a first polarizer 101 and a second polarizer 102. The liquid crystal display panel 10 further includes a first adhesive layer and a second adhesive layer not illustrated.

The first polarizer 101 and the first adhesive layer are arranged on the external main surface 130e of the first transparent substrate 130. The second polarizer 102 and the second adhesive layer are arranged on the external main surface 150e of the second glass substrate 150. The first polarizer 101 and the second polarizer 102 are arranged to extend in the display region DR entirely.

The first adhesive layer is used for bonding the first polarizer 101 to the external main surface 130e of the first transparent substrate 130. The second adhesive layer is used for bonding the second polarizer 102 to the external main surface 150e of the second glass substrate 150.

Each of the first polarizer 101 and the second polarizer 102 may be a single plate composed of a single optical member or may be a stacked plate composed of a plurality of optical members. These optical members are bonded to each other. These optical members include a polarizer (polarizing film layer). These optical members may include a protective layer (TAC layer), a phase plate, or a viewing angle compensation (wide view) film, for example.

3.9 Modulation of Light Polarizing Direction

The first polarizer 101 causes polarized light having a specific polarizing direction to pass through selectively. The liquid crystal cell 100 modulates the polarizing direction of light to pass through in response to a signal input to the liquid crystal display panel 10. The second polarizer 102 causes polarized light having a specific polarizing direction to pass through selectively. By doing so, the liquid crystal display panel 10 is given an in-plane distribution of light transmittance responsive to the signal input to the liquid crystal display panel 10.

When a control signal is input from the control substrate 13 to the liquid crystal cell 100, a pixel potential responsive to the control signal input to the liquid crystal cell 100 is applied to the pixel electrode 132. Further, a common potential is applied to the common electrode 134. By doing so, a potential difference responsive to the signal input to the liquid crystal display panel 10 is applied between the pixel electrode 132 and the common electrode 134. Then, an electric field having intensity responsive to the applied potential difference is generated between the pixel electrode 132 and the slit electrode 140. The generated electric field passes through the opening 140o at the slit electrode 140 and the liquid crystal layer 112. The electric field passing through the liquid crystal layer 112 includes a lateral electric field parallel to the internal main surface 130i of the first glass substrate 130. The lateral electric field changes the state of alignment of liquid crystal molecules in the liquid crystal layer 112. In this way, the liquid crystal cell 100 modulates the polarizing direction of light to pass through in response to the signal input to the liquid crystal display panel 10.

3.10 Pixel Region and Black Region

After light enters the liquid crystal cell 100, the light passes through the array substrate 110, the liquid crystal layer 112, the alignment film 154, and the OC layer 153 sequentially to reach the black matrix 151 and the opening 1510 at the black matrix 151. The light having reached the black matrix 151 is blocked by the black matrix 151. The light having reached the opening 1510 passes through the color filter 152 and the second glass substrate 150 sequentially to exit the liquid crystal cell 100. Thus, a region in which the black matrix 151 is arranged becomes a black region not causing exit of light to form an image. Further, regions where the openings 1510 are arranged become a plurality of pixel regions causing exit of light to form an image. The black region separates adjacent ones of the pixel regions from each other.

3.11 Display Medium Layer

As the state of alignment of liquid crystal molecules in the liquid crystal layer 112 is changed, the liquid crystal layer 112 becomes functional as a display medium layer on which a latent image is formed. The formed latent image is visualized by the backlight, the first polarizer 101, and the second polarizer 102.

3.12 Structure Resulting from Repair of Bright Point Defect

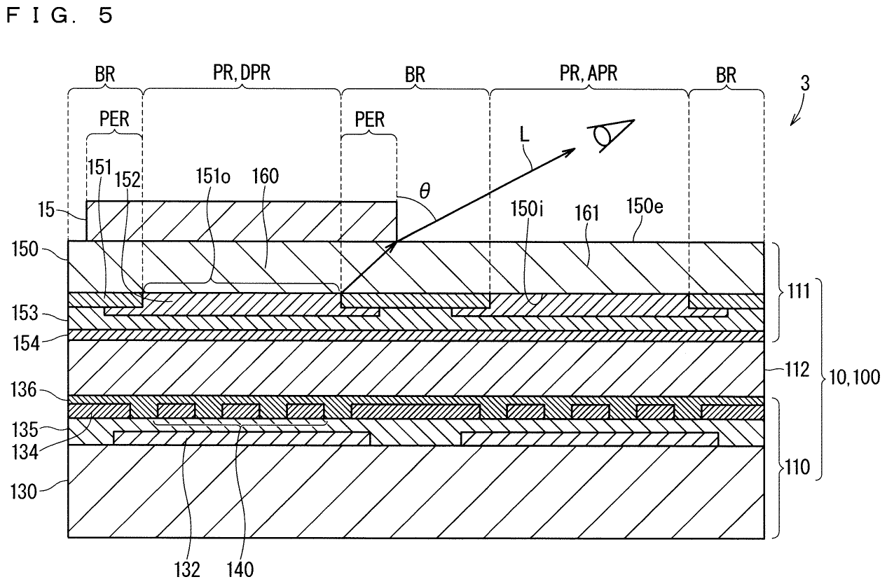

FIG. 5 is an enlarged sectional view schematically illustrating a principal part of the liquid crystal display device of the first preferred embodiment. FIG. 5 illustrates a part forming two pixels.

As illustrated in FIG. 5, the liquid crystal display device 3 includes the liquid crystal display panel 10 and a light-blocking film 15.

As illustrated in FIG. 5, the liquid crystal display panel 10 includes a plurality of pixel regions PR and a black region BR. Light to form an image is emitted from the pixel regions PR. Light to form an image is not emitted from the black region BR. As described above, the pixel regions PR are regions in which the openings 1510 at the black matrix 151 are arranged. As described above, the black region BR is a region in which the black matrix 151 is arranged.

As illustrated in FIG. 5, the pixel regions PR include a defective pixel region DPR and an adjacent pixel region APR. A bright point defect occurs in the defective pixel region DPR. A bright point defect does not occur in the adjacent pixel region APR. The adjacent pixel region APR is adjacent to the defective pixel region DPR. The black region BR separates the defective pixel region DPR and the adjacent pixel region APR from each other and has a width W2.

The defective pixel region DPR is an abnormal pixel region from which light is always emitted independently of a signal input to the liquid crystal display panel 10. In the defective pixel region DPR, due to abnormality occurring at the TFT 131 provided in a pixel having the defective pixel region DPR, for example, a potential applied to the gate electrode or the source electrode of this TFT 131 is applied as it is to the pixel electrode 132 of this pixel. Hence, in the defective pixel region DPR, a potential difference is applied between the pixel electrode 132 of this pixel and the slit electrode 140 of the same pixel independently of the signal input to the liquid crystal display panel 10 to generate a lateral electric field passing through the liquid crystal layer 112. As a result, this pixel is given light transmittance, which is always high. This pixel may be given always high light transmittance due to other reasons.

The adjacent pixel region APR is a normal pixel region from which light having a brightness level responsive to a signal input to the liquid crystal display panel 10 is emitted.

The liquid crystal display panel 10 has a guaranteed viewing angle. Thus, the liquid crystal display panel 10 is observed not only from the front but is also observed diagonally. For this reason, the liquid crystal display device 3 is required not only to make a pixel to become a bright point defect inconspicuous when observed from the front but also to make a pixel to become a bright point defect inconspicuous when observed diagonally. The liquid crystal display panel 10 is a liquid crystal display panel of a lateral field system having a wide viewing angle. Thus, the liquid crystal display device 3 has excellent contract characteristics and color balance characteristics within the wide viewing angle and has high visual quality within the wide viewing angle. Thus, the liquid crystal display panel 10 is observed diagonally within the wide viewing angle. For this reason, the liquid crystal display device 3 is required to make a pixel to become a bright point defect inconspicuous when observed diagonally within the wide viewing angle.

The light-blocking film 15 is provided for repair of a bright point defect for making a pixel to become a bright point defect inconspicuous. The light-blocking film 15 is arranged on the external main surface 150e of the second glass substrate 150. In a plan view taken from the thickness direction of the liquid crystal display panel 10, the light-blocking film 15 overlaps the defective pixel region DPR and projects from the defective pixel region DPR by a width W. Thus, in a plan view taken from the thickness direction of the liquid crystal display panel 10, the light-blocking film 15 overlaps the defective pixel region DPR and further overlaps a peripheral region PER adjacent to the defective pixel region DPR, surrounding the defective pixel region DPR, and having the width W. Further, in a plan view taken from the thickness direction of the liquid crystal display panel 10, the light-blocking film 15 overlaps the opening 1510 at the black matrix 151 in a pixel to become a bright point defect and further overlaps the black matrix 151 in the pixel to become a bright point defect. As the light-blocking film 15 overlaps the defective pixel region DPR in a plan view taken from the thickness direction of the liquid crystal display panel 10, light emitted in a direction toward the front from the defective pixel region DPR is blocked by the light-blocking film 15. This makes the pixel to become a bright point defect inconspicuous when the liquid crystal display panel 10 is observed from the front. As the light-blocking film 15 overlaps the peripheral region PER in a plan view taken from the thickness direction of the liquid crystal display panel 10, light emitted diagonally from the defective pixel region DPR is blocked or lowered. This makes the pixel to become a bright point defect inconspicuous when the liquid crystal display panel 10 is observed diagonally.

The light-blocking film 15 is made of a material having light-blocking properties. The material having light-blocking properties is black ink or black resist, for example. The material having light-blocking properties may be obtained by changing the properties of a part of an element arranged on the external main surface 150e of the second glass substrate 150. For example, the material having light-blocking properties may be obtained by changing the properties of a part of the second polarizer 102. The element to be changed in property is desirably an element close to the external main surface 150e of the second glass substrate 150, more desirably, the protective film (TAC layer) or the adhesive layer, for example, for forming the second polarizer 102.

Light emitted diagonally from the defective pixel region DPR is blocked or lowered more strongly with increase in the width W of the peripheral region PER. Thus, as the width W of the peripheral region PER becomes greater, the light emitted diagonally from the defective pixel region DPR becomes less prone to be recognized visually. In this regard, the width W of the peripheral region PER is set to be equal to or more than a lower limit width W1 that prevents visual recognition of the light emitted from the defective pixel region DPR when the liquid crystal display panel 10 is observed from within the viewing angle. For formation of the light-blocking film 15, consideration is given to position accuracy and dimensional accuracy of the light-blocking film 15 determined in the process of forming the light-blocking film 15, and a target value of the width W of the peripheral region PER is set at a minimum target value within a range in which the width W of the peripheral region PER does not fall below the lower limit width W1.

On the other hand, if the width W of the peripheral region PER is increased significantly, light emitted from the adjacent pixel region APR is blocked or lowered. Hence, increasing the width W of the peripheral region PER significantly makes it difficult to visually recognize the light emitted from the adjacent pixel region APR. In this regard, the width W of the peripheral region PER is desirably set to be equal to or less than an upper limit width that prevents difficulty in visually recognizing the light emitted from the adjacent pixel region APR. Setting the upper limit width at the width W2 of the black region BR prevents the light-blocking film 15 from overlapping the adjacent pixel region APR in a plan view taken from the thickness direction of the liquid crystal display panel 10, and prevents the light-blocking film 15 from overlapping the opening 1510 at the black matrix 151 in a pixel not to become a bright point defect in a plan view taken from the thickness direction of the liquid crystal display panel 10. As a result, the pixel not to become a bright point defect will be recognized visually without hindrance.

A viewing angle θ used for calculating the lower limit width W1 is desirably set using an observation angle as a rough indication employed in a lighting inspection conducted before shipment of the liquid crystal display device 3. This observation angle is also called an expected angle. If an inspector observes the liquid crystal display panel 10 from the observation angle set in response to the viewing angle and determines the presence or absence of a pixel to become a bright point defect in the lighting inspection, for example, the viewing angle θ is set using this observation angle as a rough indication. In calculating the lower limit width W1, it is determined whether light emitted from the defective pixel region DPR is recognized visually when observed from within the viewing angle θ. Desirably, this determination is made by following a criterion for determining the pass-fail of the liquid crystal display panel 10 in the lighting inspection conducted before shipment of the liquid crystal display device 3. If the inspector observes the liquid crystal display panel 10 through a neutral density (ND) filter and determines the presence or absence of a pixel to become a bright point defect in the lighting inspection, for example, it is determined whether light emitted from the defective pixel region DPR is recognized visually when viewed from within the viewing angle θ through the ND filter. This ND filter is an ND filter for reducing the quantity of transmitted light to one-tenth of a quantity of incident light, for example. In this case, the lower limit width W1 is a width at which visual recognition of light emitted from the defective pixel region DPR is prevented when the liquid crystal display panel 10 is observed from within the viewing angle through the ND filter for reducing the quantity of transmitted light to one-tenth of a quantity of incident light. As a result, it becomes possible to reduce influence by the specifications of a viewing angle, influence by a condition for observation of a bright point defect, influence by an observer, etc.

As illustrated in FIG. 5, the second glass substrate 150 includes a part 160 in the presence of the light-blocking film 15 and a remaining part 161. In a plan view taken from the thickness direction of the liquid crystal display panel 10, the part 160 overlaps the defective pixel region DPR and the peripheral region PER and overlaps the light-blocking film 15. The remaining part 161 is a part other than the part 160. In a plan view taken from the thickness direction of the liquid crystal display panel 10, the remaining part 161 does not overlap the defective pixel region DPR and the peripheral region PER and does not overlap the light-blocking film 15. The light-blocking film 15 is arranged on the part 160. The second glass substrate 150 has a uniform thickness. Thus, the part 160 has a thickness t, which is the same as that of the remaining part 161.

Desirably, the lower limit width W1 is calculated from a formula (1) using the set viewing angle θ, the thickness t of the part 160 of the second glass substrate 150 in the presence of the light-blocking film 15, and the refractivity n of the second glass substrate 150.

W1=t×tan{sin⁻¹(sin θ/n)} (1)

If the width W of the peripheral region PER is the lower limit width W1 calculated from the formula (1), an end portion of the light-blocking film 15 is located on an optical path of light L emitted in a direction of the angle θ diagonal to the front direction from an end portion of the defective pixel region DPR at which the light L is visually recognized most easily, as illustrated in FIG. 5. This makes the quantity of light zero emitted in this diagonal direction from the end portion of the defective pixel region DPR and not to be blocked by the light-blocking film 15, so that this light will not be recognized visually. Additionally, the light-blocking film 15 is further arranged on an optical path of light emitted in this diagonal direction from a portion other than the end portion of the defective pixel region DPR. This further makes the quantity of light zero emitted in this diagonal direction from the portion other than the end portion of the defective pixel region DPR and not to be blocked by the light-blocking film 15 to further prevent visual recognition of this light. As a result, the quantity of light emitted in this diagonal direction from the defective pixel region DPR and not to be blocked by the light-blocking film 15 becomes zero to prevent visual recognition of this light.

As a result, by using the lower limit width W1 calculated from the formula (1), it becomes possible to obtain the width W of the peripheral region PER that allows blocking of light properly emitted from the defective pixel region DPR so as to prevent visual recognition of this light when the liquid crystal display panel 10 is observed from within the viewing angle θ.

As understood from the formula (1), the lower limit width W1 becomes greater with increase in the viewing angle θ to necessitate increase in the width W of the peripheral region PER. On the other hand, if the width W of the peripheral region PER is greater than the width W2 of the black region, light emitted from the adjacent pixel region APR is blocked or lowered by the light-blocking film 15 to reduce the visual quality of the liquid crystal display device 3. In this regard, the width W of the peripheral region PER is determined optimally in consideration of the viewing angle θ, a relationship in magnitude between the width W of the peripheral region PER and the width W2 of the black region BR, the viewing angle θ on which the lower limit width W1 is dependent, the thickness t of the part 160 in the presence of the light-blocking film 15, and the refractivity n of the second glass substrate 150.

With the viewing angle θ set at the same angle as a guaranteed viewing angle of the liquid crystal display panel 10, by setting the width W of the peripheral region PER to be equal to or more than the width W1 calculated using the viewing angle θ, light emitted from the defective pixel region DPR is blocked completely when the liquid crystal display panel 10 is observed from within the guaranteed viewing angle. In this way, visual recognition of the light emitted from the defective pixel region DPR is prevented.

With the viewing angle θ set at an angle slightly smaller than the guaranteed viewing angle of the liquid crystal display panel 10, even by setting the width W of the peripheral region PER to be equal to or more than the width W1 calculated using the viewing angle θ, light emitted from the defective pixel region DPR may not be blocked completely while it is lowered when the liquid crystal display panel 10 is observed from within the guaranteed viewing angle. Even while the light emitted from the defective pixel region DPR is not blocked completely, the light emitted from the defective pixel region DPR is still lowered sufficiently to prevent visual recognition of the light emitted from the defective pixel region DPR.

Desirably, light emitted from the defective pixel region DPR is blocked completely. Thus, if a rigorous criterion is employed, the viewing angle θ is set at the same angle as the guaranteed viewing angle of the liquid crystal display panel 10. If the criterion is relaxed, however, the viewing angle θ is set at an angle slightly smaller than the guaranteed viewing angle of the liquid crystal display panel 10. In this case, the light emitted from the defective pixel region DPR is blocked completely when the liquid crystal display panel 10 is observed from within the set viewing angle θ. In this way, visual recognition of the light emitted from the defective pixel region DPR is prevented. The light emitted from the defective pixel region DPR is lowered sufficiently when the liquid crystal display panel 10 is observed from outside the set viewing angle θ and from within the guaranteed viewing angle. In this way, visual recognition of the light emitted from the defective pixel region DPR is prevented. As a result, the width W of the peripheral region PER can be set both to be equal to or more than the lower limit width W1 calculated using the viewing angle θ and to be equal to or less than the upper limit width W2.

As described above, the liquid crystal display panel 10 is a liquid crystal display panel of a lateral field system. In many cases, a liquid crystal display panel of a lateral field system is determined to be a conforming item if substantially no pixel to become a bright point defect is recognized visually when the liquid crystal display panel is observed from right and left within a viewing angle of 45°. For this reason, the viewing angle θ is desirably set at 45°.

As understood from the formula (1), as the thickness t of the part 160 in the presence of the light-blocking film becomes smaller, the ratio of the lower limit width W1 to the viewing angle θ becomes lower. This shows that reducing the thickness t makes it possible to reduce the ratio of the width W of the peripheral region PER to the viewing angle θ. Thus, with the reduced thickness t, the width W of the peripheral region PER can be set to be equal to or less than the width W2 of the black region BR easily. In other cases, if the width W of the peripheral region PER becomes unavoidably greater than the width W2 of the black region BR, a difference between the width W of the peripheral region PER and the width W2 of the black region BR can be reduced easily. This makes it possible to reduce difficulty in visually recognizing light emitted from the adjacent pixel region APR to suppress visual quality reduction at the liquid crystal display device 3. This effect is achieved if the thickness t is less than 0.3 mm. Thus, if the thickness t is less than 0.2 mm or about 0.15 mm as described above, difficulty in visually recognizing light emitted from the adjacent pixel region APR is reduced effectively to effectively suppress visual quality reduction at the liquid crystal display device 3.

3.13 Manufacture of Liquid Crystal Display Device

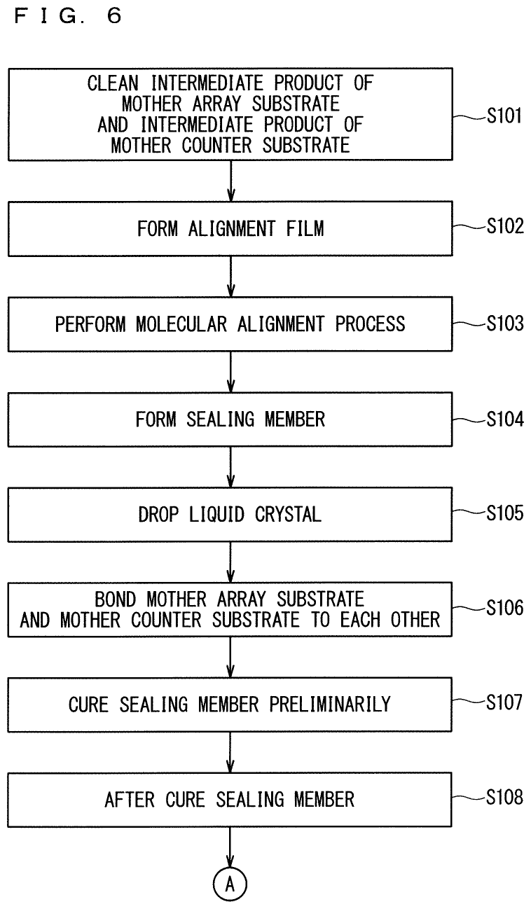

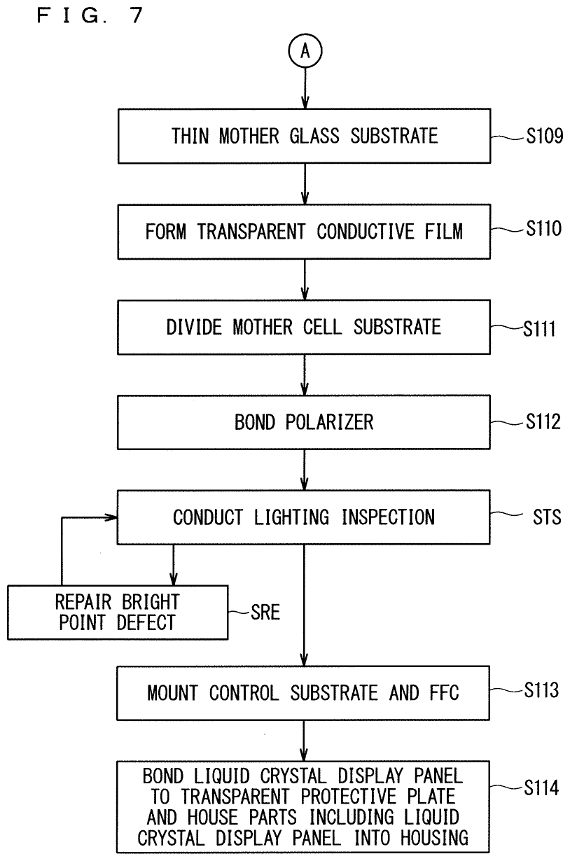

FIGS. 6 and 7 are flowcharts showing a method of manufacturing the liquid crystal display device of the first preferred embodiment.

For manufacture of the liquid crystal display device 3, the liquid crystal display device 3 is assembled from step S111 to step S114 illustrated in FIGS. 6 and 7. In step STS illustrated in FIG. 7, an intermediate product of the liquid crystal display panel 10 is subjected to a lighting inspection. In step SRE illustrated in FIG. 7, repair of a bright point defect is made in the intermediate product of the liquid crystal display panel 10 having a pixel to become a bright point defect for making the pixel to become a bright point defect inconspicuous.

For manufacture of the liquid crystal display device 3, an intermediate product of a mother array substrate and an intermediate product of a mother counter substrate are produced. For production of the intermediate product of the mother array substrate, elements including the gate line, the source line, the TFT 131, the pixel electrode 132, the common electrode 134, the insulating film 135, the signal terminal 137, etc. are formed by a general method on one of main surfaces of a mother glass substrate. For production of the intermediate product of the mother counter substrate, elements including the black matrix 151, the color filter 152, the OC layer 153, the columnar spacer, etc. are formed by a general method on one of main surfaces of a mother glass substrate. Unlike in production of a liquid crystal display device with a general liquid crystal display panel of a lateral field system, in production of the intermediate product of the mother counter substrate, the transparent conductive film 155 is not formed on the other main surface of the mother glass substrate. The reason therefor will be described below.

Steps from step S101 to S103 are performed sequentially to form the mother array substrate and the mother counter substrate from the produced intermediate product of the mother array and the produced intermediate product of the mother counter substrate respectively. The produced mother array substrate and mother counter substrate have planar shapes larger than the planar shapes of the array substrate 110 and the counter substrate 111 respectively. At least one intermediate product of the array substrate 110 and at least one intermediate product of the counter substrate 111 are allocated on the produced mother array substrate and mother counter substrate respectively.

Steps from step S104 to step S110 are performed sequentially to produce a mother cell substrate from the produced mother array substrate and mother counter substrate. The produced mother cell substrate has a planar shape larger than the planar shape of the liquid crystal cell 100. At least one liquid crystal cell 100 is allocated on the produced mother cell substrate.

As a result of implementation of step S111, at least one liquid crystal cell 100 is cut out from the produced mother cell substrate. In many cases, two or more liquid crystal cells 100 are cut out from the mother cell substrate. Cutting out a plurality of liquid crystal cells 100 from the mother cell substrate is also called “multi-faceting” of the liquid crystal cells 100.

Steps from step S112 to S114 are performed sequentially to produce the liquid crystal display panel 10 from the cut-out liquid crystal cell 100, and the liquid crystal display device 3 including the produced liquid crystal display panel 10 is assembled.

In step S101, the produced intermediate product of the mother array substrate and the produced intermediate product of the mother counter substrate are cleaned.

In subsequent step S102, the alignment film 136 is formed on one of main surfaces of the cleaned intermediate product of the mother array substrate. Further, the alignment film 154 is formed on one of main surfaces of the cleaned intermediate product of the mother counter substrate. For formation of the alignment film 136 and the alignment film 154, a coating liquid containing an alignment film material for forming each of the alignment film 136 and the alignment film 154, and a solvent are applied to form a coating film on the main surface on which each of the alignment film 136 and the alignment film 154 is to be formed. The solvent in the coating film is volatilized to dry the coating film. The alignment film material is an organic material, for example. The organic material is polyimide, for example. The coating liquid is applied onto the main surface by transferring and applying the coating liquid onto the main surface by flexographic printing process, for example. If the coating liquid is transferred and applied onto the main surface by flexographic printing process, a surface of a transfer roller is coated with the coating liquid. While the transfer roller with the applied coating liquid contacts the main surface, the transfer roller is moved in a specific transfer direction relative to the main surface. The coating film is dried by being heated with a hot plate, for example. The coating liquid is dried at a temperature of about 200° C.

In subsequent step S103, the formed alignment film 136 and alignment film 154 are subjected to molecular alignment process. The molecular alignment process is rubbing or light irradiation, for example. In this way, the mother array substrate and the mother counter substrate to be bonded to each other are produced.

In subsequent step S104, the sealing member 113 is formed on one of the main surfaces of one of the produced mother array substrate and mother counter substrate. For formation of the sealing member 113, a paste sealing agent is applied onto the main surface on which the sealing member 113 is to be formed. The sealing agent is applied using a seal dispenser machine, for example. If the sealing agent is applied using the seal dispenser machine, the sealing agent is ejected from a dispenser nozzle of the seal dispenser machine onto the main surface on which the sealing member 113 is to be formed. The sealing agent is applied to a region surrounding the display region DR and has a frame-like pattern.

In subsequent step S105, liquid crystal is dropped onto the main surface on which the sealing member 113 is formed. The liquid crystal is dropped onto a region surrounded by the region in the presence of the sealing member 113.

In subsequent step S106, the mother array substrate and the mother counter substrate are bonded to each other. The mother array substrate and the mother counter substrate are bonded to each other in a vacuum.

In subsequent step S107, the formed sealing member 113 is cured preliminarily. The sealing member 113 is cured preliminarily by applying ultraviolet light to the sealing member 113.

In subsequent step S108, the preliminarily cured sealing member 113 is after-cured. For after-curing of the sealing member 113, the sealing member 113 is heated. By doing so, the sealing member 113 is cured completely.

In subsequent step S109, the mother glass substrate of each of the mother array substrate and the mother counter substrate is thinned. For example, the mother glass substrate having a thickness of about 0.5 mm is thinned by polishing to a thickness of about 0.15 mm. In this case, the thickness of the mother glass substrate is controlled in such a manner that a center value is set at 0.15 mm and variations from the center value fall within a range of plus and minus 20%. The mother glass substrate is thinned by polishing the other main surface of the mother glass substrate by means of wet etching as chemical polishing using a chemical liquid or physical polishing of rubbing using an abrasive, for example. Thinning is also called slimming. By doing so, it becomes possible to easily obtain the liquid crystal display panel 10 having a curved shape by deforming the liquid crystal display panel 10 having a flat shape in step S114 described later.

In subsequent step S110, the transparent conductive film 155 is formed on the other main surface of the thinned mother glass substrate of the mother counter substrate. As a result, the mother cell substrate is prepared. The transparent conductive film 155 is formed by sputtering, for example. The transparent conductive film 155 is formed not during preparation of the intermediate product of the mother counter substrate but is formed in step S110 for reason that the transparent conductive film 155 is required to be formed on the other main surface of the mother glass substrate thinned in step S109.

In subsequent step S111, the produced mother cell substrate is divided into a plurality of liquid crystal cells 100. For the division of the mother cell substrate, the mother cell substrate is cut along a scribing line.

In subsequent step S112, the first polarizer 101 and the second polarizer 102 are bonded to the resultant liquid crystal cell 100. In this way, an intermediate product of the liquid crystal display panel 10 is produced.

In subsequent step STS, the resultant intermediate product of the liquid crystal display panel 10 is subjected to a lighting inspection.

The lighting inspection is conducted to determine whether the resultant intermediate product of the liquid crystal display panel 10 is a conforming item or a defective item.

For implementation of the lighting inspection, the intermediate product is subjected to inspections sequentially in terms of a point defect, a line defect, display unevenness, etc. The point defect includes a bright point defect. The line defect is caused by a disconnection of a line or a short-circuit between lines, for example. If the intermediate product of the liquid crystal display panel 10 passes all these inspections, this intermediate product is determined to be a conforming item.

The first polarizer 101 and the second polarizer 102 may be bonded in step S112 after implementation of the lighting inspection in step STS. In this case, a first polarizer for lighting inspection having the same function as the first polarizer 101 and a second polarizer for lighting inspection having the same function as the second polarizer 102 are provided at a device to be used for the lighting inspection. The lighting inspection is conducted with the first polarizer for lighting inspection arranged on the external main surface 130e of the first glass substrate 130 and with the second polarizer for lighting inspection arranged on the external main surface 150e of the second glass substrate 150.

If an inspector finds a weak bright point and the inspector is not sure whether this bright point is a bright point defect during inspection for a bright point defect, the inspector observes the intermediate product of the liquid crystal display panel 10 through the foregoing ND filter. If the inspector can still recognize the bright point visually even by observation of the intermediate product of the liquid crystal display panel 10 through the ND filter, the inspector determines that this bright point is a bright point defect.

If the intermediate product of the liquid crystal display panel 10 is determined not to have a bright point defect as a result the inspection for a bright point defect, the inspector determines this intermediate product of the liquid crystal display panel 10 to be a conforming item. If the intermediate product of the liquid crystal display panel 10 is determined to have a bright point defect, the inspector determines this intermediate product of the liquid crystal display panel 10 to be a defective item. Further, if the intermediate product of the liquid crystal display panel 10 is determined to be a defective item as a result of an inspection for a point defect, the inspector records the position, etc. of a pixel to become a bright point defect in this intermediate product. In this way, the defective pixel region DPR is identified.

In step SRE, the intermediate product of the liquid crystal display panel 10 determined to be a defective item as a result of the inspection for a bright point defect is subjected to repair of a bright point defect.

For repair of the bright point defect, the foregoing light-blocking film 15 is formed on the external main surface 150e of the second glass substrate 150. In a plan view taken from the thickness direction of the liquid crystal display panel 10, the light-blocking film 15 overlaps the defective pixel region DPR and projects from the defective pixel region DPR. Thus, in a plan view taken from the thickness direction of the liquid crystal display panel 10, the light-blocking film 15 overlaps the defective pixel region DPR and further overlaps the peripheral region PER adjacent to the defective pixel region DPR. Further, in a plan view taken from the thickness direction of the liquid crystal display panel 10, the light-blocking film 15 overlaps the opening 1510 at the black matrix 151 in a pixel to become a bright point defect and further overlaps the black matrix 151 in the pixel to become a bright point defect.

The light-blocking film 15 is made of a material having light-blocking properties. The material having light-blocking properties is black ink or black resist, for example. The material having light-blocking properties may be obtained by changing the properties of a part of an element arranged on the external main surface 150e of the second glass substrate 150. For example, the material having light-blocking properties may be obtained by changing the properties of a part of the second polarizer 102. The element to be changed in property is desirably an element close to the external main surface 150e of the second glass substrate 150, more desirably, the protective film (TAC layer) or the adhesive layer, for example, for forming the second polarizer 102.

If the material having light-blocking properties is black ink or black resist, for example, if the lighting inspection is conducted in step STS after the first polarizer 101 and the second polarizer 102 are bonded in step S112, and if a bright point defect is repaired in step SRE, the second polarizer 102 is separated once, the light-blocking film 15 is formed, and then the second polarizer 102 is bonded again. As described above, if the first polarizer 101 and the second polarizer 102 are bonded in step S112 after implementation of the lighting inspection in step STS, a bright point defect is repaired in step SRE and then the first polarizer 101 and the second polarizer 102 are bonded in step S112. In this case, the step of separating the second polarizer 102 once is omissible. This prevents damage of the second glass substrate 150 to be caused by the step of separating the second polarizer 102. This advantage works notably if the second glass substrate 150 only has a small thickness, particularly, if the second glass substrate 150 only has a thickness of about 0.15 mm so the second glass substrate 150 is prone to damage.

If the material having light-blocking properties is obtained by changing the properties of a part of the second polarizer 102, the second polarizer 102 can be left unseparated on the external main surface 150e of the second glass substrate 150 during formation of the light-blocking film 15. This prevents damage of the second glass substrate 150 to be caused by the step of separating the second polarizer 102. This advantage works notably if the second glass substrate 150 only has a small thickness, particularly, if the second glass substrate 150 only has a thickness of about 0.15 mm so the second glass substrate 150 is prone to damage. While a bright point defect should be repaired in step SRE after the first polarizer 101 and the second polarizer 102 are bonded in step S112, a determination can be made freely as to whether the bonding of the first polarizer 101 and the second polarizer 102 in step S112 or the lighting inspection in step STS is to be performed first.

In both of the case where the material having light-blocking properties is black ink or black resist, for example, and the case where the material having light-blocking properties is obtained by changing the properties of a part of the second polarizer 102, the light-blocking film 15 is required to overlap the defective pixel region DPR and is further required to overlap the peripheral region PER in a plan view taken from the thickness direction of the liquid crystal display panel 10. This requires the light-blocking film 15 to have high position accuracy and high dimensional accuracy.

Thus, if the material having light-blocking properties is black ink or black resist, for example, it is desirable that a light-blocking film be formed to overlap a region including the defective pixel region DPR and the peripheral region PER, the resultant light-blocking film be patterned by photolithography, and a part of the light-blocking film overlapping the defective pixel region DPR and the peripheral region PER be left selectively. For formation of the light-blocking film, a coating liquid containing a light-blocking material having photosensitivity is applied to form a coating film, and the resultant coating film is dried. The coating liquid is applied by printing or spin coating, for example. The printing is printing of an inkjet printing system, for example. If the light-blocking material is a positive material, for patterning of the light-blocking film, a mask with an opening having the same planar shape as the defective pixel region DPR and the peripheral region PER is prepared. Light is applied to the coating film through the opening at the prepared mask to expose the light-blocking material in the coating film to light. The light-blocking material not having been exposed to light is removed. If the light-blocking material is a negative material, for patterning of the light-blocking film, a mask with a light-blocking part having the same planar shape as the defective pixel region DPR and the peripheral region PER is prepared. Light is applied to the coating film through an opening at the prepared mask to expose the light-blocking material in the coating film to light. The light-blocking material having been exposed to light is removed. The light to be applied is ultraviolet light or laser light, for example.

If the material having light-blocking properties is obtained by changing the properties of a part of the second polarizer 102, a mask with an opening having the same planar shape as the defective pixel region DPR and the peripheral region PER is prepared. Light is applied to the second polarizer 102 through the opening at the prepared mask to change the properties of the part of the second polarizer 102 with the light. The light to be applied is ultraviolet light or laser light, for example.

After the bright point defect is repaired in step SRE, the intermediate product of the liquid crystal display panel 10 in which the bright point defect has been repaired is subjected to the lighting inspection again in step STS.

To determine whether the intermediate product of the liquid crystal display panel 10 has become a conforming item as a result of the repair of the bright point defect, the lighting inspection is conducted again to check to see again whether this intermediate product of the liquid crystal display panel 10 is a conforming item or a defective item.

The lighting inspection may be conducted again by conducting inspections for all of a point defect, a line defect, display unevenness, etc. Alternatively, by giving importance to a determination as to the correctness of the repair of the bright point defect, an inspection for a bright point defect may be conducted. For implementation of an inspection for a bright point defect, the intermediate product of the liquid crystal display panel 10 may be inspected to determine whether light emitted from the defective pixel region DPR is visually recognized when observed diagonally. For example, the inspection may be conducted to determine whether light emitted from the defective pixel region DPR is visually recognized when the intermediate product of the liquid crystal display panel 10 is observed from right and left at an angle of 45°. The inspection may be conducted to see a degree to which the light emitted from the defective pixel region DPR is recognized visually. For this inspection, the intermediate product of the liquid crystal display panel 10 is observed through the ND filter.

In subsequent step S113, the control substrate 13 and the FFC 14 are mounted on the intermediate product of the liquid crystal display panel 10 initially determined to be a conforming item or determined to become a conforming item as a result of repair of the bright point defect. In this way, formation of the liquid crystal display panel 10 is finished.

In subsequent step S114, the finished liquid crystal display panel 10 is bonded with the transparent adhesive sheet 12 to the transparent protective cover 11. As a result, the liquid crystal display panel 10 having a flat shape is deformed to obtain the liquid crystal display panel 10 having a curved shape. Then, with the backlight arranged to face the back side 10b of the liquid crystal display panel 10 across the optical sheet, the liquid crystal display panel 10, the transparent protective cover 11, the transparent adhesive sheet 12, the control substrate 13, the FFC 14, the backlight, and the optical sheet are housed in the housing. In this way, formation of the liquid crystal display device 3 is finished.

3.14 Effect of the Invention of First Preferred Embodiment

According to the invention of the first preferred embodiment, light emitted from the defective pixel region DPR is not recognized visually when the liquid crystal display panel 10 is observed from within a viewing angle. This makes a pixel to become a bright point defect inconspicuous when the liquid crystal display panel 10 is observed from within the viewing angle. Preventing visual recognition of light emitted from the defective pixel region DPR when the liquid crystal display panel 10 is observed from within the viewing angle does not require significant increase of the light-blocking film 15. This makes it unlikely that a pixel adjacent to the pixel to become a bright point defect will be hidden. This makes it possible to provide the display device 3 having high visual quality.

### 4 Second Preferred Embodiment

4.1 Liquid Crystal Display Device

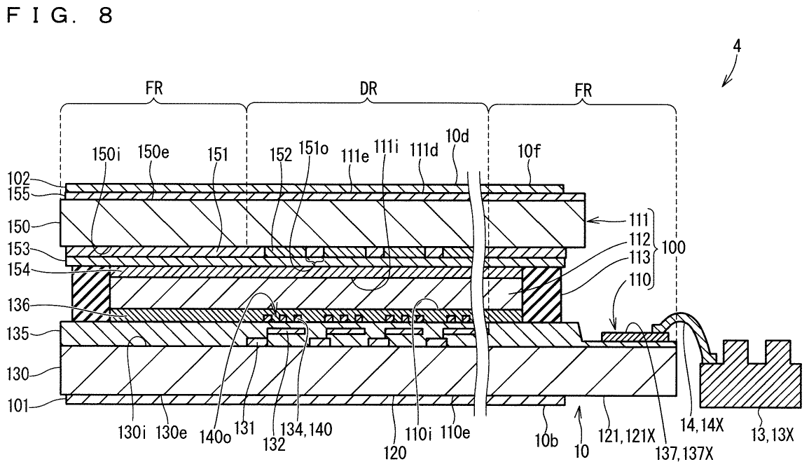

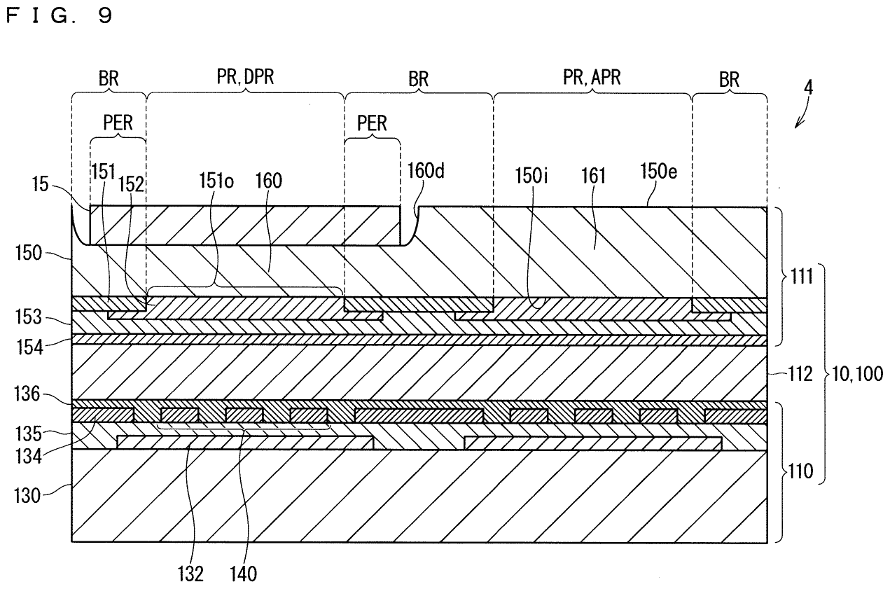

FIG. 8 is a sectional view schematically illustrating the liquid crystal display device of the second preferred embodiment. FIG. 9 is an enlarged sectional view schematically illustrating a principal part of the liquid crystal display device of the second preferred embodiment. FIG. 9 illustrates a part forming two pixels.

In the following description, attention is given to a difference of a liquid crystal display device 4 of the second preferred embodiment illustrated in FIGS. 8 and 9 from the liquid crystal display device 3 of the first preferred embodiment illustrated in FIGS. 3 and 5. Structures of the liquid crystal display device 4 of the second preferred embodiment not to be described are the same as those employed in the liquid crystal display device 3 of the first preferred embodiment.

In the first preferred embodiment, the liquid crystal display device 3 is a curved liquid crystal display device. For this reason, the display surface 10d of the liquid crystal display panel 10 is curved. As the liquid crystal display panel 10 having a curved shape should be obtained by deforming the liquid crystal display panel 10 having a flat shape, the first glass substrate 130 and the second glass substrate 150 desirably have a thickness of less than 0.2 mm. Further, as the liquid crystal display panel 10 is required to be fixed while being deformed into the curved shape, the transparent protective cover 11 and the transparent adhesive sheet 12 originally having the curved shapes are provided to the liquid crystal display device 3.

By contrast, in the second preferred embodiment, the liquid crystal display device 4 is a flat liquid crystal display device. For this reason, the display surface 10d of the liquid crystal display panel 10 is flat. As the liquid crystal display panel 10 having a flat shape is not required to be deformed, the first glass substrate 130 and the second glass substrate 150 may have a thickness of 0.2 mm or more. However, the first glass substrate 130 and the second glass substrate 150 desirably have a thickness of less than 0.3 mm, more desirably, a thickness of about 0.25 mm. In this case, the thickness of each of the first glass substrate 130 and the second glass substrate 150 is controlled in such a manner that a center value is set at 0.25 mm and variations from the center value fall within a range of plus and minus 20%. A glass substrate provided at a general liquid crystal display device has a thickness of from about 0.3 to about 0.5 mm. Thus, the thickness of each of the first glass substrate 130 and the second glass substrate 150 is smaller than that of the glass substrate provided at the general liquid crystal display device. In this way, the liquid crystal display device 4 becomes thinner and lower in weight than the general liquid crystal display device. Further, as the liquid crystal display panel 10 is not required to be fixed while being deformed into a curved shape, the transparent protective cover 11 and the transparent adhesive sheet 12 formed into curved shapes are not provided to the liquid crystal display device 4. In some cases, however, the liquid crystal display device 4 may include a transparent protective cover and the transparent adhesive sheet 12 having flat shapes. The transparent protective cover having the flat shape may be replaced with a different type of front cover. For example, the transparent protective cover having the flat shape may be replaced with a touch panel. If the touch panel is provided at the liquid crystal display device 4, the liquid crystal display device 4 equipped with the touch panel is obtained. The provision of the front cover and the transparent adhesive sheet 12 to the liquid crystal display device 4 improves the resistance of the liquid crystal display device 4 to external pressure applied from the direction of the front side 10f of the liquid crystal display panel 10 and improves the moisture resistance of the liquid crystal display device 4.

In the first preferred embodiment, the thickness of the second glass substrate 150 is uniform. Thus, the part 160 in the presence of the light-blocking film 15 has the same thickness t as the remaining part 161.

By contrast, in the second preferred embodiment, the thickness of the second glass substrate 150 is nonuniform and reduced locally in a region in the presence of the light-blocking film 15. For this reason, the part 160 in the presence of the light-blocking film 15 has a smaller thickness t than the remaining part 161. The part 160 has a recess 160d formed at the external main surface 150e of the second glass substrate 150. The light-blocking film 15 is housed in the recess 160d.

As described above, as the thickness t of the part 160 in the presence of the light-blocking film 15 becomes smaller, the ratio of the width W of the peripheral region PER to the viewing angle θ can become lower. Thus, in the presence of the light-blocking film 15 on the part 160 having a smaller thickness than the remaining part 161, the ratio of the width W of the peripheral region PER to the viewing angle θ can be reduced compared to the presence of the light-blocking film 15 on the part 160 having the same thickness as the remaining part 161. For example, in the presence of the light-blocking film 15 on the part 160 having a thickness of 0.15 mm smaller by 0.1 mm than the thickness of 0.25 mm of the remaining part 161, the ratio of the width W of the peripheral region PER to the viewing angle θ can be reduced compared to the presence of the light-blocking film 15 on the part 160 having a thickness of 0.25 mm same as the thickness of 0.25 mm of the remaining part 161. Further, in the presence of the light-blocking film 15 on the part 160 having a thickness of 0.15 mm smaller by 0.1 mm than the thickness of 0.25 mm of the remaining part 161, the ratio of the width W of the peripheral region PER to the viewing angle θ can be reduced like in the presence of the light-blocking film 15 on the part 160 of the second substrate 150 having a uniform thickness of 0.15 mm.

Thus, by housing the light-blocking film 15 in the recess 160d, the width W of the peripheral region PER can be set more easily to be equal to or less than the width W2 of the black region BR. In other cases, if the width W of the peripheral region PER becomes unavoidably greater than the width W2 of the black region BR, a difference between the width W of the peripheral region PER and the width W2 of the black region BR can be reduced more easily. This makes it possible to reduce difficulty in visually recognizing light emitted from the adjacent pixel region APR to a greater extent to suppress visual quality reduction at the liquid crystal display device 4 to a greater extent.

As long as the thickness t of the part 160 in the presence of the light-blocking film 15 is less than 0.3 mm, repair of a bright point defect takes effect even if the thickness of the remaining part 161 is 0.3 mm or more. This makes it possible to achieve the effect of repairing a bright point defect, even if the second substrate 150 with the remaining part 161 of a thickness of 0.3 mm or more is required to be used for reason of manufacture of the liquid crystal display device 4.

The part 160 in the presence of the light-blocking film 15 provided in the liquid crystal display device 3 of the first preferred embodiment may include the recess 160d. If the part 160 provided in the liquid crystal display device 3 of the first preferred embodiment includes the recess 160d, the width W of the peripheral region PER can also be set more easily to be equal to or less than the width W2 of the black region BR by housing the light-blocking 150 in the recess 160d. In other cases, if the width W of the peripheral region PER becomes unavoidably greater than the width W2 of the black region BR, a difference between the width W of the peripheral region PER and the width W2 of the black region BR can also be reduced more easily. This makes it possible to reduce difficulty in visually recognizing light emitted from the adjacent pixel region APR to a greater extent to suppress visual quality reduction at the liquid crystal display device 3 to a greater extent.

Desirably, the light-blocking film 15 has the same thickness as the depth of the recess 160d. This improves the flatness of the external main surface of an element composed of the second glass substrate 150 and the light-blocking film 15. As a result, it becomes possible to reduce the probability of mixture of air bubbles between the second glass substrate 150 and the second adhesive layer or between the second adhesive layer and the second polarizer 102 during bonding of the second polarizer 102 onto the external main surface 150e of the second glass substrate 150 using the second adhesive layer.

If the second substrate 150 has a uniform thickness of less than 0.3 mm, the part 160 in the presence of the light-blocking film 15 and without the recess 160d still has a thickness of less than 0.3 mm. Thus, even if the recess 160d is omitted from the part 160, the thickness of less than 0.3 mm of the second substrate 150 still achieves the foregoing effect of repairing a bright point defect.

4.2 Manufacture of Liquid Crystal Display Device

In the following description, attention is given to a difference of a method of manufacturing the liquid crystal display device 4 of the second preferred embodiment from the method of manufacturing the liquid crystal display device 3 of the first preferred embodiment illustrated in FIGS. 6 and 7. Steps of manufacturing the liquid crystal display device 4 of the second preferred embodiment not to be described are the same as those employed in manufacturing the liquid crystal display device 3 of the first preferred embodiment.

In manufacturing the liquid crystal display device 3 of the first preferred embodiment, each mother glass substrate having a thickness of about 0.5 mm is thinned by polishing to a thickness of about 0.15 mm in step S109, for example. In this case, the thickness of the mother glass substrate is controlled in such a manner that a center value is set at 0.15 mm and variations from the center value fall within a range of plus and minus 20%.

By contrast, in manufacturing the liquid crystal display device 4 of the second preferred embodiment, each mother glass substrate having a thickness of about 0.5 mm is thinned by polishing to a thickness of about 0.25 mm in step S109, for example. In this case, the thickness of the mother glass substrate is controlled in such a manner that a center value is set at 0.25 mm and variations from the center value fall within a range of plus and minus 20%.

In manufacturing the liquid crystal display device 3 of the first preferred embodiment, the light-blocking film 15 is formed on the flat external main surface 150e of the second glass substrate 150 for repair of a bright point defect in step SRE.

By contrast, in manufacturing the liquid crystal display device 4 of the second preferred embodiment, the recess 160d is formed at the external main surface 150e of the second glass substrate 150 for repair of a bright point defect in step SRE. After formation of the recess 160d, the light-blocking film 15 is formed on the external main surface 150e of the second glass substrate 150. The light-blocking film 15 is formed in the recess 160d.

After the first polarizer 101 and the second polarizer 102 are bonded in step S112, a lighting inspection is conducted in step STS. If a bright point defect is to be repaired in step SRE, the second polarizer 102 is separated once, the recess 160d and the light-blocking film 15 are formed, and the second polarizer 102 is bonded again in step SRE. As described above, if the first polarizer 101 and the second polarizer 102 are bonded in step S112 after implementation of the lighting inspection in step STS, a bright point defect is repaired in step SRE and then the first polarizer 101 and the second polarizer 102 are bonded in step S112. In this case, the step of separating the second polarizer 102 once is omissible. This prevents damage of the second glass substrate 150 to be caused by the step of separating the second polarizer 102.

The recess 160d is formed while the second polarizer 102 is not bonded to the external main surface 150e of the second glass substrate 150 so the external main surface 150e of the second glass substrate 150 is exposed. The recess 160d is formed by glass processing technique. The glass processing technique is wet etching, dry etching, laser etching, or lithography, for example. Carbon dioxide gas laser or excimer laser is used for the laser etching, for example. A diamond needle or a cemented carbide needle is used for the lithography, for example.

Desirably, the recess 160d is formed by the glass processing technique having high position accuracy and high dimensional accuracy. This makes it possible to reduce difficulty in recognizing light visually emitted from the adjacent pixel region APR due to overlap of a lateral side of the recess 160d with the adjacent pixel region APR. For example, the recess 160d is formed by performing wet etching or dry etching through a resist mask with an opening having the same planar shape as a region in which the recess 160d is to be formed. Alternatively, the recess 160d is formed by performing laser etching through a photomask with an opening having the same planar shape as a region in which the recess 160d is to be formed.

If the recess 160d is formed by wet etching or dry etching through a resist mask, it is desirable that the mother glass substrate of the mother counter substrate be thinned in step S109 and the recess 160d be formed in step SRE continuously. For example, after wet etching or dry etching is performed through a resist mask, the resist mask is removed. After removal of the resist mask, wet etching or dry etching is performed again. This eliminates the need for an additional chemical liquid, an additional a processing device, etc. for forming the recess 160d, so that the recess 160d is formed efficiently.

If the mother glass substrate of the mother counter substrate is thinned in step S109 and the recess 160d is formed in step SRE continuously, the defective pixel region DPR is required to be identified before the mother glass substrate of the mother counter substrate is thinned in step S109 and the recess 160d is formed in step SRE. However, at a time before the mother cell substrate is divided into a plurality of liquid crystal cells 100 in step S111, inputting a signal to the liquid crystal cell 100 is difficult. This makes it difficult to conduct a lighting inspection before the mother glass substrate of the mother counter substrate is thinned in step S109 and the recess 160d is formed in step SRE. For this reason, it is difficult to identify the defective pixel region DPR through implementation of the lighting inspection before the mother glass substrate of the mother counter substrate is thinned in step S109 and the recess 160d is formed in step SRE. In this regard, to thin the mother glass substrate of the mother counter substrate in step S109 and form the recess 160d in step SRE continuously, the defective pixel region DPR is identified by a point defect inspection other than the lighting inspection. In the point defect inspection other than the lighting inspection, a point defect is detected by detecting the amount of leakage of charge held in a storage capacity to identify the defective pixel region DPR, for example.

Instead of thinning the mother glass substrate in step S109, the lighting inspection may be conducted in step STS after the mother cell substrate is divided into a plurality of liquid crystal cells 100 in step S111, and the glass substrate at the intermediate product of the liquid crystal display panel 10 may be thinned after implementation of the lighting inspection in step STS. This makes it possible to thin glass substrate and form the recess 160d in step SRE continuously.

A material having light-blocking properties for forming the light-blocking film 15 formed in the recess 160d is desirably black ink or black resist, for example.

In this case, like in manufacturing the liquid crystal display device 3 of the first preferred embodiment, a light-blocking film is formed to overlap a region including the defective pixel region DPR and the peripheral region PER, the resultant light-blocking film is patterned by photolithography, and a part of the light-blocking film overlapping the defective pixel region DPR and the peripheral region PER is left selectively. By doing so, the light-blocking film 15 having high position accuracy and high dimensional accuracy is formed in the recess 160d.

If the formed recess 160d has high position accuracy and high dimensional accuracy, the light-blocking film 15 having high position accuracy and high dimensional accuracy may be formed in a self-aligned manner using the recess 160d. For example, paste containing black ink, for example, may be printed to the interior of the recess 160d by means such as printing of an inkjet printing system to form a printed film. The viscosity of the resultant printed film may be reduced by heating, for example, to extend the printed film over the interior of the recess 160d entirely. Alternatively, paste containing black ink, for example, may be applied to the interior of the recess 160d and its surrounding to form a coating film. An unnecessary part of the coating film formed around the recess 160d may be wiped off by running a squeegee, for example, over the external main surface 150e of the second glass substrate 150 to leave the coating film only in the recess 160d.

In manufacturing the liquid crystal display device 3 of the first preferred embodiment, the finished liquid crystal display panel 10 is bonded with the transparent adhesive sheet 12 to the transparent protective cover 11 originally having a curved shape in step S114. As a result, the liquid crystal display panel 10 having a flat shape is deformed to obtain the liquid crystal display panel 10 having a curved shape. Then, with the backlight arranged to face the back side 10b of the liquid crystal display panel 10 across the optical sheet, the liquid crystal display panel 10, the transparent protective cover 11, the transparent adhesive sheet 12, the control substrate 13, the FFC 14, the backlight, and the optical sheet are housed in the housing.

By contrast, in manufacturing the liquid crystal display device 4 of the second preferred embodiment, if the liquid crystal display device 4 does not include a front cover, the finished liquid crystal display panel 10 is not bonded to a front cover with the transparent adhesive sheet in step S114. In this step, with the backlight arranged to face the back side 10b of the liquid crystal display panel 10 across the optical sheet, the liquid crystal display panel 10, the control substrate 13, the FFC 14, the backlight, and the optical sheet are housed in the housing. If the liquid crystal display device 4 includes a front cover having a flat shape, the finished liquid crystal display panel 10 is bonded to the front cover having the flat shape with a transparent adhesive sheet. Then, with the backlight arranged to face the back side 10b of the liquid crystal display panel 10 across the optical sheet, the liquid crystal display panel 10, the front cover, the transparent adhesive sheet, the control substrate 13, the FFC 14, the backlight, and the optical sheet are housed in the housing.

4.3 Effect of the Invention of Second Preferred Embodiment

According to the invention of the second preferred embodiment, like in the invention of the first preferred embodiment, light emitted from the defective pixel region DPR is not recognized visually when the liquid crystal display panel 10 is observed from within a viewing angle. This makes a pixel to become a bright point defect inconspicuous when the liquid crystal display panel 10 is observed from within the viewing angle. Preventing visual recognition of light emitted from the defective pixel region DPR when the liquid crystal display panel 10 is observed from within the viewing angle does not require significant increase of the light-blocking film 15. This makes it unlikely that a pixel adjacent to the pixel to become a bright point defect will be hidden. This makes it possible to provide the display device 4 having high visual quality.

### 5 Display Medium Layer, Pixel Region, and Black Region in Organic EL Display Device

As long as the second substrate 150 is a transparent substrate and a plurality of pixel regions PR may include the defective pixel region DPR, the display device 1 in which a bright point defect is to be repaired may be a display device other than the liquid crystal display device 2. The display device other than the liquid crystal display device 2 may be a self light-emitting display device. The self light-emitting display device may be an organic electroluminescence (EL) display device. If the display device 1 is the self light-emitting display device, a light-emitting layer in which a visible image is formed functions as a display medium layer. Additionally, a region to emit light in a pixel functions as the pixel region PR to emit light, and a region not to emit light located between regions to emit light functions as the black region BR not to emit light.

The preferred embodiments of the present invention can be combined freely, and each preferred embodiment can be modified or omitted, where appropriate, within a range of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a display panel with a plurality of pixel regions to emit light, the pixel regions including a defective pixel region where a bright point defect has occurred, the display panel including a first substrate, a display medium layer, and a second substrate, the second substrate facing the first substrate across the display medium layer, being transparent, including a part having a thickness of less than 0.3 mm, and having a main surface on the opposite side to the arrangement side of the first substrate; and
a light-blocking film arranged on the main surface and on the part, and overlapping the defective pixel region and projecting from the defective pixel region by a width W in a plan view taken from the thickness direction of the display panel, the width W being equal to or more than a width W1 that prevents visual recognition of light emitted from the defective pixel region when the display panel is observed from within a viewing angle.

2. The display device according to claim 1, wherein
the pixel regions include an adjacent pixel region adjacent to the defective pixel region,
the display panel further includes a black region not to emit light, the black region separating the defective pixel region and the adjacent pixel region from each other and having a width W2, and
the width W is equal to or less than the width W2.

3. The display device according to claim 1, wherein
the width W1 is a width calculated from a formula (1) using a set viewing angle θ, a thickness t of the part, and a refractivity n of the second substrate:
W1=t×tan{sin⁻¹(sin θ/n)} (1).

4. The display device according to claim 1, wherein
the set viewing angle θ is 45°.

5. The display device according to claim 1, wherein
the width W1 is a width that prevents visual recognition of the light emitted from the defective pixel region when the display panel is observed from within the viewing angle through a neutral density filter for reducing a quantity of transmitted light to one-tenth of a quantity of incident light.

6. The display device according to claim 1, wherein
the second substrate includes a remaining part other than the part,
the part has a smaller thickness than the remaining part and has a recess formed at the main surface, and
the light-blocking film is housed in the recess.

7. The display device according to claim 1, wherein
each of the first substrate and the second substrate is a glass substrate having a thickness of less than 0.2 mm, and
the display panel has a curved shape.

8. The display device according to claim 1, wherein
the display panel is a liquid crystal display panel of a lateral field system.

9. A method of manufacturing a display device comprising the steps of:
a) preparing a display panel with a plurality of pixel regions to emit light, the pixel regions including a defective pixel region where a bright point defect has occurred, the display panel including a first substrate, a display medium layer, and a second substrate, the second substrate facing the first substrate across the display medium layer, being transparent, including a part having a thickness of less than 0.3 mm, and having a main surface on the opposite side to the arrangement side of the first substrate; and
b) forming a light-blocking film on the main surface and on the part, the light-blocking film overlapping the defective pixel region and projecting from the defective pixel region by a width W in a plan view taken from the thickness direction of the display panel, the width W being equal to or more than a width W1 that prevents visual recognition of light emitted from the defective pixel region when the display panel is observed from within a viewing angle.
